(19) United States
(12) Patent Application Publication
(10) Pub. No.: US 2009/0254643 A1
(43) Pub. Date: Oct. 8, 2009

(54) SYSTEM AND METHOD FOR IDENTIFYING GALLERIES OF MEDIA OBJECTS ON A NETWORK

(76) Inventors: Merijn Camiel Terheggen, Groningen (NL); Eldert Jasper van Wijngaarden, Groningen (NL); Feike Jan Galema, Schoonoord (NL); Edwin Ronald Alexander Krikke, Berlicum (NL); Mathijs Homminga, Groningen (NL); Magne Roar Groenhuis, Groningen (NL)

Correspondence Address: MAHAMEDI PARADICE KREISMAN LLP, 4880 STEVENS CREEK BOULEVARD, SUITE 201, SAN JOSE, CA, 95129-1034, US

(21) Appl. No.: 12/098,251

(22) Filed: Apr. 4, 2008

(51) Int. Cl. G06F 15/16

(52) U.S. Cl. 709/223

(57) ABSTRACT

Collections of media objects may be aggregated from network resources available over a network. An embodiment provides that a network resource is accessed at each of a plurality of network locations. The network resource is analyzed at each network location to determine whether the network resource includes, or provides access to, any or all media objects in a set of multiple media objects that collectively satisfy one or more editorial criteria for being deemed a gallery, as presented at the network location or network locations where the multiple media objects are provided. The information about the set of media objects may be stored.

### TECHNICAL FIELD

The disclosed embodiments relate to a system and method for identifying galleries of media objects on a network.

### BACKGROUND

With the Internet, numerous search engines and searching techniques have been developed. Search engines such as provided by GOOGLE INC. and YAHOO INC. enable searching for text, images, or videos. There is a trend to increase the kinds of data that users are capable of searching.

Concurrently with the development of search engines, web-based content is increasingly more visual. Individuals have blogs managed at service sites such as Flickr and YouTube. Businesses uses images and movies to promote products. And the search engines enable image and movie searching using a variety of techniques.

### BRIEF DESCRIPTION OF THE DRAWINGS

FIG. 1 illustrates a gallery aggregation and retrieval and presentation system, according to an embodiment of the invention.

FIG. 2 illustrates a method for enabling identification and use of galleries of media objects, according to an embodiment.

FIG. 3 illustrates processes that may be implemented in order to identify and use galleries of media objects presented at various network locations on the World Wide Web (or the ‘Internet’), according to an embodiment of the invention.

FIG. 4 illustrates a system for identifying and indexing galleries of media objects over a network, according to an embodiment.

FIG. 5 illustrates more details of a system architecture such as shown and described with FIG. 4, according to an embodiment.

FIG. 6A illustrates a method employed by a gallery determination module to identify media objects that are part of a gallery, according to an embodiment.

FIG. 6B illustrates a first kind of trail or hunt for media objects of a gallery.

FIG. 6C illustrates a second kind of trail or hunt for media objects of a gallery.

FIG. 7 illustrates a system for creating presentations of images that comprise a gallery in response to submission of one or more selection criteria, according to an embodiment.

FIG. 8 illustrates a presentation that may be generated from a site and displayed to a user via a web browser, under an embodiment of the invention.

FIG. 9A illustrates a system for enabling sponsorship of gallery renderings, under an embodiment of the invention.

FIG. 9B thru FIG. 9D illustrate presentation layers for use with a system such as described with FIG. 9, under one or more embodiments of the invention.

FIG. 10 illustrates a server-side system to implement or enable any of the embodiments described herein.

### DETAILED DESCRIPTION

Galleries include media object presentations that are hosted or provided on a network. Typically, a gallery of media objects includes an organized or creative bundle of images or video clips, although sound, text and other content is often included or provided as part of a gallery. Some typical (but not required) characteristics of galleries include a gallery page or presentation, where copies or renditions of media objects that comprise the gallery are provided at one location. But as described below, the media objects that comprise a gallery are often distributed over multiple linked pages, presentations or network resources. When provided together on one network resource, the media objects may be separated by positioning or even temporarily (e.g. Flashing sequence of images). In this regard, galleries can be diverse in the manner of their appearance and network architecture.

In general, a gallery corresponds to a set or collection of media objects that are related by topic and/or other attributes, such as like location/time of creation, author, appearance depiction of visual content (e.g. the physical objects that are depicted). As such, the media objects that comprise a gallery often share a characteristic or attribute that is perceptible to human perception, in a manner that enables a human to consider the media objects are being interrelated based on the shared characteristic or attribute.

Galleries often derive from sources that desire to communicate a passion, experience or enthusiasm about the shared characteristic or attribute (e.g. about the author or the subject matter of what a set of images depict). Galleries may also reflect the opinion or status of a discussion/development/movement within a community that the gallery creator is part of. The way in which subjects and other attributes of the media objects in a gallery collection are used contain unique and meaningful information about what the collection and the objects in the collection communicate; much akin to how the distribution of words in a document determines what is communicated by the document.

Embodiments described herein combine the information that is related to a set of media objects, as well as the information that is specific or related to individual media objects that is part of a gallery, in order to searching and selecting interfaces and presentations.

A “media object” includes visual content items, including images (JPEG, GIF BMP or similar formats), animated graphics (GIF file), video clips or segments, or the combination of visual content items and other forms of data (e.g. picture and text/or audio). Media objects may also extend to streaming media, including FLASH media where the user may receive a rendition of a “live” or occurring event. Thus, a media object may include streams, or binary sets of programmatic instructions and data (e.g. like a Flash movie, which is a combination of scripts and content that is rendered by the script/programmatic elements).

A “gallery” refers to a collection of media objects that individually reside at a source location and are presented at their respective source locations in a manner that reflects a common characteristic. The common characteristic may reflect editorial considerations, such as unity of content, theme, authorship, or source of creation. In some (but not all) cases, the media objects that comprise the gallery are generally presented together. In the context of a network such as the Internet, the media objects of a gallery may be distributed on the same page (or presentation or resource), or on different pages (or presentations or resources) that are related to one another as parent-child, siblings, parent-grand-child, or otherwise part of an internal network system that is linked directly or indirectly to other pages that contain other media objects of the same gallery, where the pages that contain and separate the media objects have a common point of access and share the theme or editorial considerations of the gallery. In some other cases, for example, sub pages or sub presentations can provide some elements or constitutes of a gallery.

A “network resource” includes data that is renderable or otherwise available to a browser or other network navigation component at a network location. Examples include a page or web-based presentation or portions thereof or a media object as described above.

Collections of media objects may be aggregated from network resources available over a network. An embodiment provides that a network resource is accessed at each of a plurality of network locations. The network resource is analyzed at each network location to determine whether the network resource includes, or provides access to, any or all media objects in a set of multiple media objects that collectively satisfy one or more editorial criteria for being deemed a gallery, as presented at the network location or network locations where the multiple media objects are provided. The information about the set of media objects may be stored.

One or more embodiments described herein may be implemented using modules. A module may include a program, a subroutine, a portion of a program, a software component or a hardware component capable of performing a stated task or function. As used herein, a module can exist on a hardware component such as a server independently of other modules, or a module can exist with other modules on the same server or client terminal, or within the same program.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, Flash memory (such as carried on many cell phones and personal digital assistants (PDAs)), and magnetic, optical and other memory. Computers, terminals, network enabled devices (e.g. mobile devices such as cell phones and PDA's) are all examples of machines and devices that utilize processors, memory, and instructions stored on computer-readable mediums.

Overview

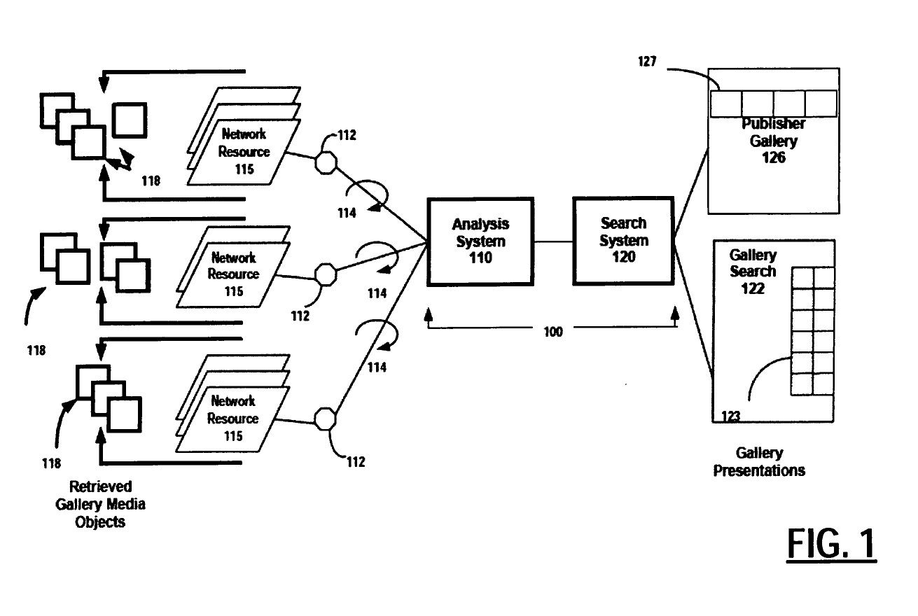

FIG. 1 illustrates a gallery aggregation, analysis, retrieval and presentation system, according to an embodiment of the invention. An embodiment such as described may be used to aggregate information and/or content to enable gallery presentations to be provided in connection with various kinds of user-experiences, such as in connection with a search engine.

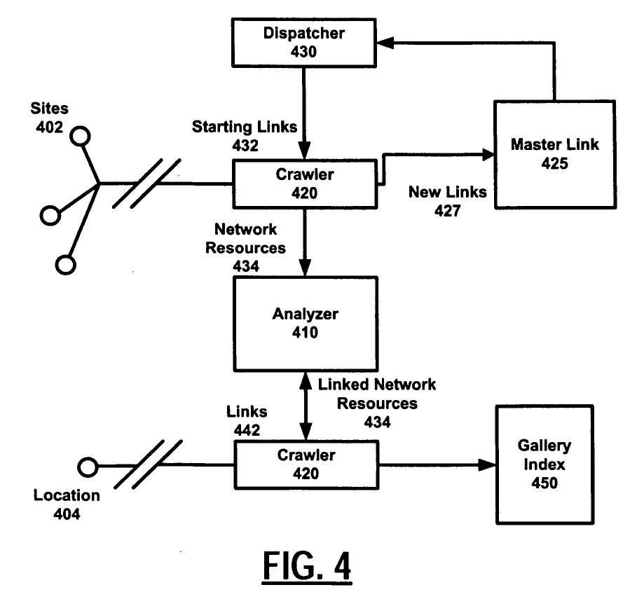

The gallery aggregation, analysis, retrieval and presentation system 100 includes an analysis system 110 and a retrieval and presentation system 120. Each system 110, 120 may be provided through use of one or more modules or components and/or data structures (e.g. see FIGS. 4, 5 and 7). The aggregation and analysis system 110 includes programmatic elements that access network sites and internal network locations in order to identify galleries, or constituents of galleries, and to aggregate information about the galleries and/or its constituents. Likewise, the retrieval and presentation system 120 includes programmatic elements that enable presentation(s) of the galleries based on the information aggregated from the aggregation and analysis system 110. In one embodiment, the presentation of the galleries may be provided at either a host site of system 100, and/or at third-party affiliate sites/locations of the host site.

The aggregation and analysis system 110 may operate at a back-end element of the system to continuously or repeatedly crawl sites 112 on the network (such as over the Internet) to detect presence of galleries. The aggregation and analysis system 110 may access individual sites 112 to detect and store information about galleries. Each gallery may include a collection of media objects, such as image media, image/text media or video clips.

The aggregation and analysis system 110 executes one or more processes 114 that inspect resources 115 (e.g. web pages or documents) available at each of those sites. The resources 115 may be provided at internal or linked network locations that are accessible trough network navigation of the resource at each of the sites 112. For example, the resources 115 may be structured in tree- or graph-form or as a hierarchy that is traversable by a component of the aggregation and analysis system 110 (e.g. see crawler 420 of FIG. 4).

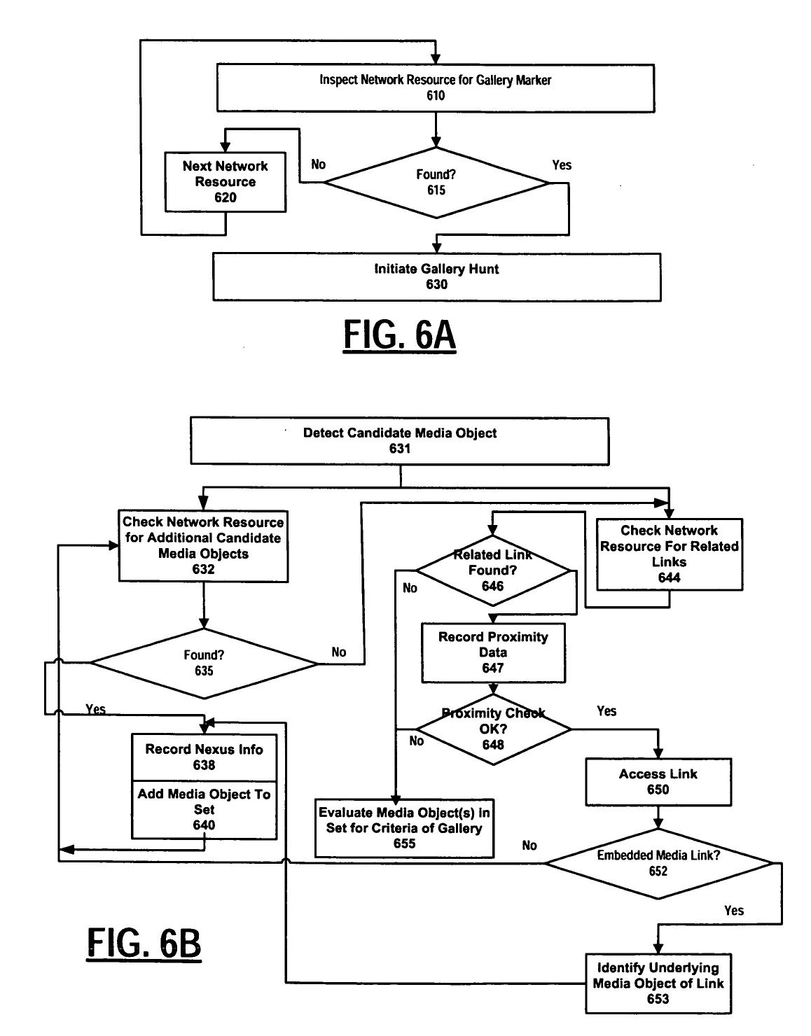

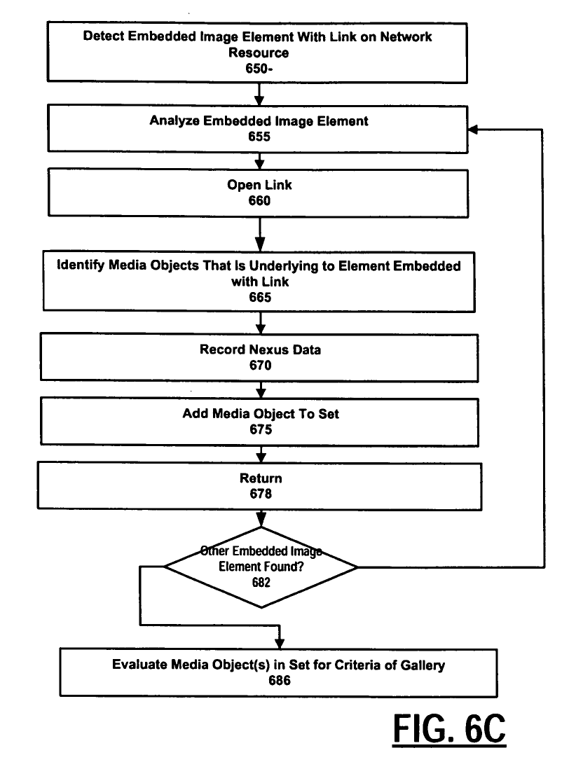

In an embodiment, individual resources 115 correspond to web-based presentations (e.g. pages, dynamic web content) that contain a combination of text, images, layout and other visual structures (such as HTML tables or CSS (cascading style sheets) can have fields and colors which can be used to ‘imitate’ images). Each site 112 may include internal locations that individually include one or more media objects of a gallery. Alternatively, the sites 112 may access other network locations where media objects are provided. In many cases, the aggregation and analysis system 110 may access numerous sites that do not provide galleries, such as sites with pages that have disparate images or text-only. Thus, in one implementation, the aggregation and analysis system 110 may lack a priori knowledge as to whether a site or its internal or accessed network locations (where resources 115 are provided) contain galleries. Rather, the aggregation and analysis system 110 may perform a ‘dumb crawl’ to inspect resources (e.g. web pages) on the fly, without advance knowledge as to the presence of galleries. In another implementation, the aggregation and analysis system 110 may be enhanced or oriented to scan for clues on network sites for the locations of galleries. For example, the aggregation and analysis system 110 may respond to words ‘my photo-album’ that appear on any page by automatically accessing a link associated with those words to scan for gallery collections of images. As described with other embodiments, clues to the presence of a gallery may be formulated from the presence of media objects, such as, for example, (i) media objects embedded with links to other resources with underlying or full-sixed versions of the media objects (see FIG. 6C), or (ii) media objects (thumbnails or large versions) provided together on a gallery page (see FIG. 6B). With regard to any of the embodiments described, detection of a marker or clue of a gallery may trigger a targeted and iterative process to locate media objects and to determine whether those media objects satisfy editorial criteria for being considered a gallery.

Each identified gallery may be in the form of a collection of media objects 118 (e.g. image files) that are either presented on the same page together, or displayed on a cluster of pages or resources. In many cases, media objects 118 may be distributed on a cluster of resources 115, such as a cluster of web pages that are directly linked to one another, or in a cluster of pages that are linked to a common source page (e.g. siblings). In an embodiment, the media objects that comprise a given gallery include image files (or image content items, such as provided by FLASH or programmatic elements) that can be displayed together on a web page, web-based presentation, or presented as thumbnails or links with separate network locations (e.g. each link may access a separate image file), or otherwise distributed across a cluster of web pages or web-based presentations that have a closely linked relationship. The closely linked relationship may correspond to at least some of the media objects being directly linked to one another, or directly linked to a common network page or location. For example, the media objects that are detected as part of the gallery detection process may be distributed across web pages that are linked as parent child sets, siblings, or parent-grandchild.

In an embodiment, the processes 114 are executed to detect the presence of any one of many possible kinds of galleries. According to one embodiment, the processes 114 include (i) a process to detect media objects that are candidates to be part of one or more galleries; (ii) processes to perform, or control performance of, actions at individual sites to identify media objects; (iii) various analysis operations to determine whether a given collection of candidate media objects comprise a gallery. With regard to media object detection, an embodiment provides that the processes 114 may scan web pages or other resources for images, embedded images, and/or links to other images. The actions that may be performed as part of the gallery detection process includes link navigation or directed browsing, as well as page or link parsing. In an embodiment, both candidate media objects and data associated with those candidate media objects may be parsed and analyzed against some reference to determine whether candidate media objects form a gallery. According to an embodiment, the aggregation and analysis system 110 implements rules that define editorial criteria as to whether a given collection of candidate media objects are to be deemed a gallery.

The editorial criteria may be established as part of design or implementation of an embodiment. In one implementation, the editorial criteria defines conditions of (i) placement of the media objects, (ii) the relative network location where the individual media objects are stored (sometimes referred to as ‘proximity information’), and/or (iii) topical or subject matter information of the individual media objects (sometimes referred to as ‘nexus information’), as determined from data provided with or otherwise associated with the media objects. Based on such parameters, series of programmatic determinations may be made to determine whether a given collection of detected media objects satisfy the editorial criteria for being considered a gallery.

In addition to gallery detection, the aggregation and analysis system 110 may aggregate or otherwise obtain other information from detected galleries. In one embodiment, the other information includes a topical or category determination to enable association of key words or search terms with the detected galleries. As will be described, the topical or category determinations may be determined from scanning text, using layout or editorial information known about the resource on which one of the media objects is presented (e.g. identify a title of a page or presentation having the one or more media objects of a gallery). Authority sources may also be used to identify information of topic or category about a media presentation. Thus, a relevancy determination may be made for a determined subject matter, category or keyword of a detected gallery or the individual media objects that comprise the gallery.

Other information that may be obtained when detecting gallery presence at one of the sites 112 includes (i) network locations of individual media objects that are deemed to comprise the gallery, and (ii) copies or renditions (e.g. thumbnail or shrunken) of media objects that comprise the detected gallery. All the information determined from gallery detection may be indexed, or otherwise stored in a database or data structure that is made available to the retrieval and presentation system 120.

In one embodiment, the retrieval and presentation system 120 may be part of a gallery search system that retrieves renditions of galleries in response to criteria that is provided from some source, such as a user or an element of programming hosted at a third-party site. The renditions of galleries may match search terms that correspond to the criteria. In one implementation, the renditions may be in the form of (moving/animated) thumbnails that are selectable to navigate the selector to the original site where the media objects that comprise the gallery were derived from.

In one embodiment, the retrieval and presentation module 120 may be part of a media object search system that retrieves renditions of media objects in response to criteria that is provided from some source, such as a user or an element of programming hosted at a third-party site. The renditions of media objects may match search terms that correspond to the criteria. In one implementation, the renditions may be in the form of (moving/animated) thumbnails that are selectable to navigate the selector to the original site where the media objects were derived from.

Still further, according to one or more embodiments, the retrieval and presentation system 120 enables renditions of galleries may be displayed as a gallery search presentation 122. The gallery search presentation 122 may display gallery presentations 123 that are search results to search queries provided from a user. As described elsewhere, the gallery presentations 123 may also display sponsored links and gallery renditions, as well as other media, content or information.

According to one implementation, a search result containing a rendition of a gallery may include preview elements such as thumbnails or animated miniature presentations (with Flash/streaming/caching for instance) of the media objects in the collection. As will be described, search results may also be combined with sponsored gallery renditions and/or links. A typical presentation that can be used to display a search result or a sponsored search result is a textual title/heading of the search result combined with a series of visual representations of the media objects in the collection and some additional information like summary, URL and potentially other collection attributes like amount of media objects and tags/subjects categories of the objects and/or the collection. By being able to see a set of several search results in one overview where each search result includes visual representations of the referred media object collections, embodiments facilitate the user in evaluating which entries of the search result best matches his or interests. Among other benefits, the renditions of galleries reduce the desire or need of the user to open or select any of the links associated with a gallery rendition or its media objects/components. Still further, gallery renditions improve upon user interaction and feedback mechanisms in which knowledge and input of users is used to improve the results and the mechanisms that lead to the search results.

As described in greater detail below, one or more embodiments may be used to enable search system 120 to provide presentation functionality (like searching) on an index of media object presentations (collections of media objects). Examples of media objects include photo albums, image galleries or movie galleries. As illustrated by other embodiments (e.g. See FIG. 4), a retrieval and presentation system may be powered by a functional back end. The retrieval and presentation system may extend to components operated by different parties, such as portals, blogs, news sites, vertical/niche sites, and search sites (Kalooga.com).

The functionality provided from the aggregation and analysis system 110 may be used in different forms, depending on the type of retrieval and presentation system that the functionality is integrated with. Typical forms are a search box, full search page, integrated gallery result linking to a full search results page or to a gallery page, a textual or image link to search results page or to gallery page, combination of a search result and a search box integrated together, a list of words that each link to a set of search results or sponsored search results, etc. Implementations can vary and include HTML, XML/XSLT, Javascript, Flash, AIR, Prism, Silverlight, and other publishing technologies/products.

According to an embodiment, the aggregation and analysis system may be equipped with an application program interface for any one of many retrieval and presentation systems. For any given combination of an aggregation and analysis system and retrieval and presentation system, the methods of communication between the systems via the application program interfaces may be by way of XML or DHTML, and can be extended to support programmatic access using other communication types like REST, RPC and others.

Still further, other types of retrieval and presentation systems may be incorporated as an alternative or addition to search systems or as a sub-part of another publication system or thirds party site. According to one embodiment, the aggregation and analysis system 110 may be used to generate gallery renditions for a publisher presentation 126. The publisher presentation 126 may be enabled by a publisher interface or service. One or more toolsets or interface components may be provided with the system as a whole so as to enable publishers (e.g. operators or services providing web sites) to display gallery renditions 127 on the publisher presentation 126. In an embodiment, the gallery renditions 127 may be based on search criteria generated through programmatic elements that operate with the publisher site or resource. An example of such programmatic components include ‘widgets’. Such publishers may manage their own widgets or programmatic elements. Instances of widgets and group of instances of widgets are configured to function on a specific page/site/channel only.

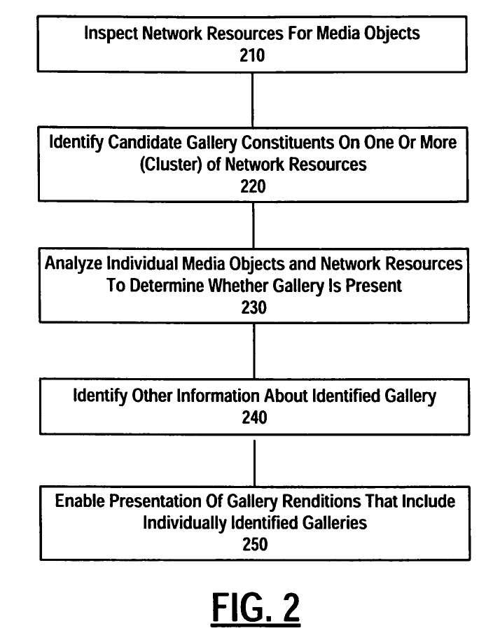

FIG. 2 illustrates a method for enabling identification and use of galleries of media objects, according to an embodiment. A method such as shown by FIG. 2 may be implemented a computing process, involving primarily programmatic (i.e. through execution of software code) and/or automatic (without human intervention steps). As a computer implemented step, results and input used in the steps described may be represented through data. A computer, or combination of computers may be used to perform steps described. Such computers may employ processors, embedded memory elements, storage components, and network interfaces or communication components. Examples of the types of machines that may be used include servers (in a client-server architecture) or terminals acting as peers (in a peer-to-peer architecture). Still further, an embodiment (or portion thereof) may be provided as a network service for other computing services and architectures.

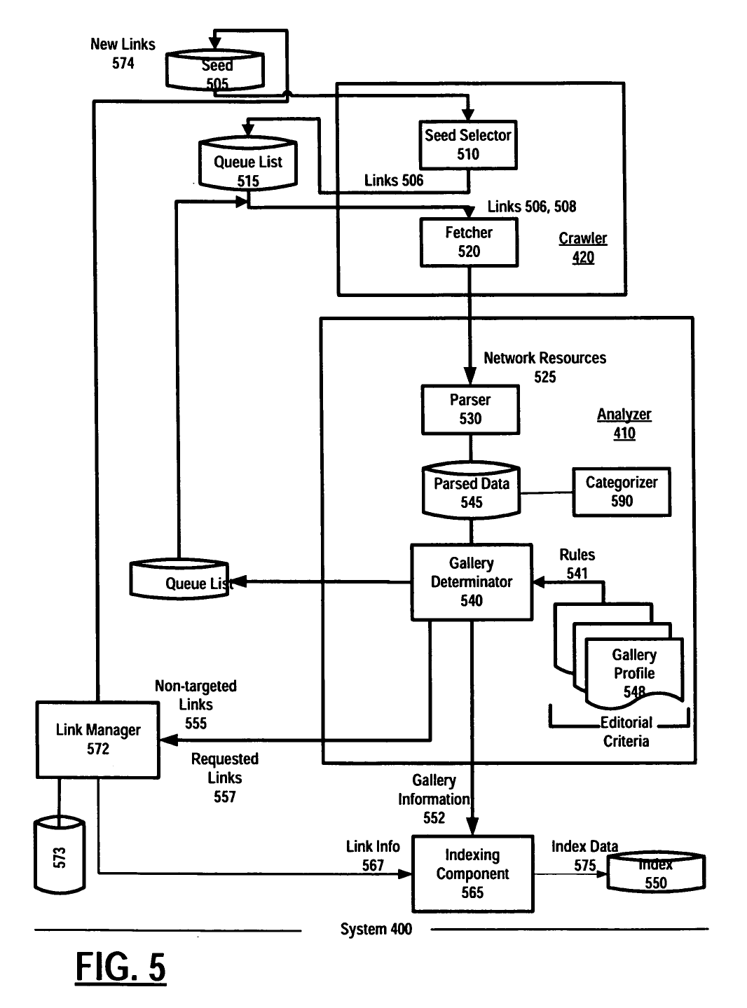

In a step 210, network resources, such as in the form of web pages, web-based presentations, or other network accessible files are inspected or analyzed for presence of media objects. In an embodiment, the network resources are identified for analysis by either (i) being crawled, or (ii) targeted for inspection. As described with one or more other embodiments, some sites or network locations may be crawled in attempt to crawl all known sites, or sites known or used in a collection. For example, a gallery aggregation system such as described with an embodiment of FIG. 4, or in more detail with FIG. 5, may crawl a list of known locations on the Internet (or on a network or subset of a network) to refresh or updates its gallery information. Some resources are targeted in that there may be some prior knowledge or evidence that the network resource may contain a media object that is part of an undetermined gallery comprising other media objects that have been detected.

In step 220, a given network resource or cluster of network resources is inspected for purpose of identifying its visual gallery media object(s) that have potential to be a gallery constituent. In one embodiment, a media object that is a potential gallery element may be detected on one network resource, resulting in identification of other network resources via linked relationships with the resource that contained the identified or suspected media object. Thus, each network resource in the cluster may be inspected individually, and one or more other network resources in the cluster may be identified as a result of a previous inspection of another network resource. In another implementation, a given network resource is scanned for links or other linked resources, as well as for other resources that link to the given network resource. A cluster may be identified from at least a portion of the identified linked resources. Network resources in the cluster may be scanned concurrently or after identification of the cluster of network resources.

In an embodiment, step 210 and step 220 may be performed together, meaning network resources in the cluster are identified as a result of an iterative process to identify other media objects that can comprise potential gallery constituents. For example, a web page or web-based presentation may be accessed (step 210) and analyzed to identify a first media object (step 220). Other linked pages are identified in content surrounding the first media object (step 220). The other pages may be accessed for other media objects (step 210) and then analyzed for media objects (step 220). In this regard, the process of identifying network resources and media objects may be an iterative or repetitive process, spanning multiple media objects and/or web pages or web-based presentations provided on one or more network resources.

Step 230 provides that individual media objects appearing on a given network resource or cluster are analyzed with or against other media objects to determine whether those media objects form a portion of a gallery. As described elsewhere, editorial criteria are used in determining whether media objects appearing on a web page or web-based presentation or at different network locations are declared a gallery. Rules may implemented to identify different editorial criteria that can also accommodate different types of galleries. As an example, the editorial criteria used in gallery determination may be in pursuit of a goal to identify and present media objects that are programmatically deemed to be sufficiently united by some criteria (e.g. theme or subject matter and network source) to an extent that agrees with human judgment. As with previous steps, gallery determination may be an iterative process. The analysis of the media objects may involve at least one or more of the following (i) comparing metadata or information associated with media objects being analyzed; (ii) comparing other data appearing on the network resource on which the media object(s) under analysis appear, including data surrounding a media object under analysis; (iii) analyzing the media objects themselves; (iv) analyzing data or network resources that refer or link to the gallery or the media objects it comprises; (v) analyzing the referring references themselves.

Once a gallery is identified, step 240 provides that other information about the gallery is identified or determined. This information may correspond to, for example, descriptive information, such as the title of the gallery and/or keywords that appear on or are related to the page or appear with or are related of text presented with the reduces scale presentations of the media objects of the gallery or with the media objects of the gallery or with other intermediate layers and elements. Other information, such as relevance or authority to a particular category may also be determined.

Step 250 provides that gallery information is stored to enable presentations of gallery renditions that include individually identified galleries. For each identified gallery, the gallery information that is stored may include gallery rendering data and gallery descriptive information. The gallery rendering data includes (i) location data (e.g. URLs) that can be used to retrieve individual media objects that comprise the gallery; (ii) renditions or versions of the media objects that comprise the gallery (e.g. thumbnails or reduced scale versions of images; still frames of video clips or video streams; reduced scale versions of video clips or video streams); or (iii) duplicates of the media objects that comprise the gallery. The gallery descriptive information may include gallery titles, text appearing with or text related to the gallery or text appearing with or related to the media objects of the gallery, keywords and other descriptive information determined from the media objects or network resources (e.g. web pages) that provide the media objects, or determined from data or network resources that refer or link to the gallery or the media objects or from the referring network resources.

According to one or more embodiments, the gallery information may be stored through indexing processes to enable subsequent search or selection processes. Accordingly, the stored gallery data may be provided for use in creating gallery presentations as part of a gallery search or selection process.

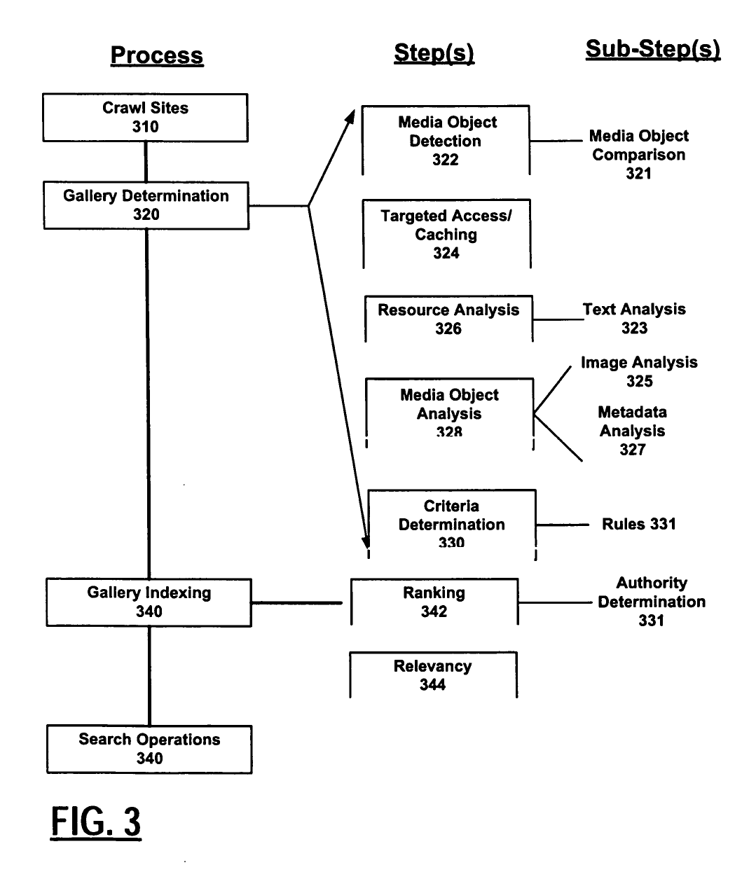

FIG. 3 illustrates processes that may be implemented in order to identify and use galleries of media objects presented at various network locations on the World Wide Web (or the ‘Internet’), according to an embodiment of the invention. While an embodiment such as described with FIG. 3 is specific to Internet, other networks or sub-networks (such as intranets) may be used for one or more implementations. Processes such as described may be used to implement, for example, any of the embodiments described with FIG. 1 or FIG. 2. Such processes may be computer-implemented, such as through execution of software by a combination of processors and memory, storage, and network interfaces or communication elements. As an alternative or addition, any of the processes or co-processes described may be performed through use of modules, or combination of modules or other programmatic components.

According to an embodiment, gallery identification and use may be provided by processes that include crawling 310, gallery determination 320, a gallery indexing 330, and search enablement 340. Each process may include numerous steps or sub-steps, some of which are described in more detail below. Still further, other processes may include more or fewer processes other than those expressly described.

Crawling process 310 identifies network resources for inspection of visual media objects that potentially comprise a gallery. Crawling process 310 may be implemented to gather (i) network resources when there is minimal advance knowledge of gallery media object presence, and/or (ii) network resources targeted for gallery media objects based on analysis of other linked or related resources. For example, the crawling process 310 may be designed (i) to access all network locations that are known and available to a system at a given time period, (ii) to access network locations that are suspected or known for containing media object galleries, based on, for example, past results, and (iii) to access specific network locations that are linked or otherwise identified with a media object of another resource that is a gallery candidate or component. Thus, in a given system, multiple instances of the crawling process 310 may be implemented. Still further, the crawling process 310 may be controlled or used by other components as part of an iterative process to identify a gallery of media object on multiple network resources. In the latter case, the crawling process 310 may be used to provide access to targeted network resources.

Gallery determination process 320 determines presence of galleries comprising multiple media visual media objects on a network resource or cluster of network resources. The gallery determination process 320 may execute several sub- or co-processes in identifying any given gallery of media objects. These sub- or co-processes include media object detection 322, targeted accessing 324, network resource analysis 326, media object analysis 328 and gallery criteria determination 330. Numerous galleries of various types may be identified. Still further, numerous types of media objects, including various types of data formats may be determined. Each identified gallery may conform to some editorial criteria or conditions that dictate whether (i) a given media object is to be considered a part of a gallery containing other media objects, and/or (ii) a set of media objects collectively satisfy conditions for considering the media objects a gallery.

With the sub- or co-process of media object detection 322, a programmatic component may scan or inspect individual network resources to detect both media objects that are part of potential gallery candidates. This would include media objects that are renditions of corresponding or underlying media objects. In the latter case, media object detection 322 may first detect linked or embedded media objects. Linked or embedded media objects may be in the form of thumbnails or image elements embedded with a link or programmatic segment of the resource. Such programmatic segments may include scripts, Java Applets, ActiveX controls, Flash elements, ADOBE AIR elements, Mozilla Prism, or Microsoft Silverlight elements. Upon detecting a linked, referred or embedded media object, media object detection 322 may detect a link to a network resource that is likely to contain an underlying media resource, access that media resource (e.g. using targeted access sub-process 324) and perform or execute media object comparison 321.

Media object comparison 321 refers to a process or series of steps (or programmatic component) in which an underlying media object for a thumbnail or embedded image element (or reduced size version of rendition of a media object) is located through comparisons of characteristics of the linked or referred or embedded media object and individual media objects on the linked or referred network resource. In one embodiment, media object comparison 321 is used to determine characteristic information about an embedded or linked media object. Such characteristic information may include, for example, (i) dimensions or aspect ratio of the image element (or reduced size version or rendition of a media object), (ii) presence and/or positioning of text surrounding the image element(or reduced size version or rendition of a media object), (iii) keywords or language used in the text surrounding the image element(or reduced size version or rendition of a media object), or (iv) image characteristic, such as the hue of elements of one or more regions of the image element or a histogram of the image elements ((or reduced size version or rendition of a media object), or (v) category or subset of projects present in, a set of images. When the network resource that is linked to that embedded image element is opened, media object comparison 321 steps provide that the network resource is scanned for a larger image element that has some or all of the same characteristics (e.g. same aspect ratio, same text caption, same internal image characteristics, same color distribution characteristics, same ‘fingerprint’ or distinctive characteristic.).

As an example, the process of media object detection 322 may be performed on a given web page to identify a thumbnail image that is embedded with a link. Characteristic information about the thumbnail image may be determined as part of the detection process. Media object detection 322 may direct or control targeted access process 324 (see below) to retrieve a second web page that is located by the link embedded with the thumbnail. Media object detection 322 may scan the second web page for media objects, and obtain characteristic information for one or more media objects that appear on that second page. The comparison 321 portion of the media object detection 322 may compare the characteristics to determine which image file, for example, on the second page corresponds to the thumbnail of the first page.

As indicated, targeted access and caching 324 may refer to process or step performed in connection with other sub-steps to process links for purpose of identifying media objects that are candidates for galleries under identification or consideration. As mentioned previously, media objects that comprise galleries may be distributed over various network locations, many times linked off a common gallery page. Network resources that contain media objects for consideration in galleries are often linked directly, or indirectly through other pages. To this end, in order to identify galleries of media objects that share, for example, a common theme, links identified with media objects are typically used to access linked network resources for other media objects. The targeted access and caching 324 may access network resources that are linked to or provided with media objects of a gallery that is under identification. In this way, the targeted access and caching 324 may enable iterative or progressive steps in which media objects are individually identified and analyzed to form a constituent of a gallery.

The sub- or co-process of network resource analysis 326 may analyze the network resource that contains a given media object in order to determine information for use in determining whether criteria for satisfying gallery determination (see sub-process 330) are satisfied. For a given media object, the network resource analysis 326 may be used to determine, for example, contextual and layout information about individual media objects that comprise a portion of a gallery. The network resource analysis 326 may also be used to determine links or references to other media resources from the network resource under analysis that may pertain or contain media objects for a gallery. Contextual information may include identification of descriptive information, including key words or title, that may identify theme or context of a media object. Layout information may determine when media objects relate or correspond to one another. For example, a gallery maybe deciphered from images that share captions that contain similar/related keywords and which present the caption in identical/similar positions.

In one embodiment, network resource analysis 328 includes text analysis operations 323. Examples of text analysis operations include key word extraction, caption analysis, title identification, link or URL analysis, categorization or summarization.

The sub- or co-process of media object analysis 328 includes determining metadata and other information about the contents of individual media objects. Accordingly, metadata analysis operations 327 may be used to determine metadata about individual media objects under analysis or consideration for galleries. Examples of metadata information includes information that determines the aspect ratio or dimension of the media object, information about the source of the media object (such as an author or upload source), date of creation of the media object, the data size of the media object, or the positioning of the media object with other media objects. In an embodiment, image analysis operations 325 may be used to extract information about the contents of images or characteristics of pixels appearing in images (e.g. hue at corners). Results of the media objects analysis 328 may be used in determining both gallery affiliation and whether one media object is a rendition or copy of another (e.g. whether a thumbnail is the same picture as an underlying image of another network resource).

The gallery criteria determination 320 utilizes various rules 331 that define multiple types of galleries. In particular, the rules 331 may define editorial criteria that define various gallery profiles or types. In this way, the rules 331 may be implemented to determine whether a gallery is present, or whether a given media object is part of a gallery. The gallery criteria determination 320 may compare information known about individual or sets of media objects to the editorial criteria that is defined by the rules. This information may include information or results determined from other sub- or co-processes. In order to determine whether conditions or criteria for gallery determination are met, the gallery criteria determination 330 may identify information that includes (i) relationship to the network location of the network resources that contain the media objects that are to comprise the gallery (i.e. ‘proximity information’); (ii) determination of common themes or content shared by the media objects that comprise the gallery (i.e. ‘nexus information’). Information about the location of network resources that contain media objects of a gallery includes, for example, (a) whether the media objects that comprise the gallery are on a common page or network resource, (b) whether the media objects that comprise the gallery are directly linked or referenced from a common source page (e.g. the network resources that contain the media objects of the gallery are siblings, or share a parent-child relationship with a common network resource), or (c) whether the media objects that comprise the gallery are indirectly linked, to each other or to a common page.

In addition to such location information of network resources containing media objects, editorial criteria implemented by rules 331 may require some other conditions or criteria that provides a nexus as to whether the media objects in the various linked relationships satisfy the gallery conditions. Such additional nexus information may be determined in part from results of the resource analysis 326 or media object analysis 328. In one embodiment, results of network resource analysis 326 may be used to identify title, key words category or theme that are shared amongst media objects of a gallery under identification. Results of the media objects analysis 328 identify whether a nexus exists between different media objects for purpose of considering the different media objects part of the same gallery (as defined by editorial criteria). According to an embodiment, other sub-processes not described may be performed to determine some or additional nexus information. Examples of nexus information include a determination of a theme, such as displayed on title or deciphered through keywords. Other examples of nexus information include authorship, metadata (such as color dominance in images), commonality in pages that link to the media objects that are candidates for a gallery (e.g. a gallery of what teenagers consider to be ‘most popular’), and commonality in pages that are linked from the network resources of the candidate media objects.

The gallery criteria determination 330 may also consider some factors that are strong indicators of the presence of galleries. For example, in one implementation, these indicators may result in a presumption that a set of media objects are a gallery, unless disqualified by some other criteria. In another implementation, the presence of some factors may reduce or eliminate the need for nexus information. One such factor is when media objects that comprise the gallery appear on a common page and/or under a common heading or title (e.g. the presence of a gallery page having thumbnails and or full size images clustered together). Another such factor includes media objects that are identified from a common set of thumbnails or embedded image elements that appear together on a page or resource. Still further, the presence of keywords with a set of links or images may be indicative of a gallery. For example, ‘fan pages’ of celebrities may contain numerous links. The name of the celebrity, appearing in the URL or title, for example, along with the combination of images and separated links may be indicative that the images on the fan page and the images appearing on the pages that are separately linked from the home page may comprise one gallery.

In an embodiment, galleries and the media objects that form galleries are indexed for subsequent search, selection, navigation, or contextual matching operations that enable gallery presentations. An indexing process 340 may determine and index information about galleries, including information that identifies individual media objects that comprise the gallery, information for enabling subsequent locating and retrieval of the media objects, and descriptive information or key words. Additionally, one or more embodiments provide for storing in the index actual copies of media objects that comprise individual galleries, including copies that are renditions or reduced duplicates (e.g. thumbnail versions of images that comprise the gallery). The indexing process 340 may use results of sub- or co-processes or operations performed in, for example, the gallery determination process 320. In an embodiment, output from performing sub- or co-process of network analysis 326 is used to identify descriptive information, including key words, categories, titles for identified galleries. Results in the form of information identified from media object analysis 328 may also be stored in the index process 340. In this way, an index 340 may be created that lists galleries, media objects that comprise the galleries, and associates descriptive information about the galleries.

An index that is populated with results of index process 340 may enable subsequent search or selection operations. For a given category, key words, search term, vector, string pattern, or regular expression, indexing may implement algorithms or processes to enable ranking of items that comprise a search result. For example, galleries associated with common search terms (e.g. ‘Puerto Rico’) may be numerous. In an embodiment, the indexing process 340 may use sub-processes that implement ranking 342 and/or relevancy 344. Under one embodiment, a ranking algorithm may count the number of network resources that link to resources that provide, or are used to provide, network resources on which individual media objects of a given gallery are provided. For example, a cluster of network pages that are deemed to pertain to ‘Puerto Rico’ (e.g. official Puerto Rico site sponsored by the local government) may be highly ranked because numerous other pages on the World Wide Web link to it. Still further, ranking or relevancy may be determined or influenced by other sites that are known to be ‘authorities’ on the particular category. For example, the official government site for Puerto Rico may be an authority because it is the most linked gallery site that pertains to the topic of Puerto Rico. It may provide a link to ‘Caribbean Beaches’ galleries. Given the authority of the Puerto Rico page that links to it, the gallery that is provided through the link to ‘Caribbean Beaches’ may receive a high relevancy and ranking score for the term.

In an embodiment, processes for enabling search or selection of galleries may be enabled. These processes include providing interfaces for enabling criteria generation, through manual or programmatic input.

System Architecture

FIG. 4 illustrates a system for identifying and indexing galleries of media objects over a network, according to an embodiment. A system such as described may be used to implement any or all of the processes such as described with embodiments of FIG. 3, or perform a method such as described with an embodiment of FIG. 2. In more detail, a system 400 includes modules or components in the form of an analyzer 410 and one or more crawlers 420. In an embodiment, analyzer 410 may be used in connection with separate instances of crawler 420.

A dispatcher 430 may be used to provide seed or starting links 432 to network sites where network resource retrieval processes are performed to identify galleries of media objects at network locations known to the system. The process initiated by dispatcher 430 may be ‘dumb’ in that no advance knowledge may be available as to whether the sites crawled are to contain galleries of media objects. Alternatively, the process initiated by the dispatcher 430 may be semi-intelligent, in that the dispatcher may select links that are suspected or have prior history of holding galleries. The dispatcher 430 may access its links from a master link data structure 425. Links may be selected based on criteria that include when the link was last used, or the source of the link identification, or link popularity, or link change-rate, or custom boost factor based on editorial criteria. As will be described with an embodiment of FIG. 5, one output of analyzer 410 are links that the system 400 may use for subsequent non-targeted crawl operations.

When supplied a link 432, crawler 420 may (i) access and retrieve the network resource 434 from sites 402, and (ii) identify network locations on the retrieved network resource to crawl further. In this way, the crawler 420 may retrieve and supply network resources 434 to the analyzer 410. The analyzer 410 may perform processes to extract or otherwise identify different forms of data and information contained on the individual network resources 434. According to an embodiment, the analyzer 410 may perform some or all of the sub- or co-processes of the gallery determination process 320 (see FIG. 3). In one implementation, analyzer 410 receives one or more network resources 434 and performs sub- or co-processes of media object detection 322 (FIG. 3), network resource analysis 326 (FIG. 3) and media object analysis 328 (FIG. 3).

In response to detecting a media object that is embedded or otherwise provided with a link 442, the analyzer 410 requests another instance of the crawler 420 to perform a targeted access of locations 404 in order to retrieve one or more linked network resources 444. The linked network resources 444 may be returned for analysis. The linked network resources 444 may be analyzed to determine whether the media object with the embedded link has an underlying media object. Additionally, analyzer 420 may analyze the network resource 434 returned from the crawler 410 in order to detect links or link chains (i.e. a series of links) to other media objects that are potential candidates for a common gallery. In this way, analyzer 410 may make additional requests specifying identified links 442 as part of an iterative process to identify either underlying media objects (e.g. full images linked to thumbnails) or other media object elements for a single gallery.

On an operative scale, the analyzer 410 may operate to identify multiple galleries concurrently. As such, numerous instances of the crawler 420 may be used to perform targeted resource retrievals. A cache may be used to enable resource distribution while a plethora of media objects and network resources are analyzed at one time by numerous instances of the analyzers.

Another function that may be performed by the crawler 420 is to identify and store (e.g. in the master link data structure 425) newly identified links 427. Newly identified links 427 may be identified in the course of the various fetching or crawling operations. Either the crawler 420 or analyzer 410 may be configured to identify new links, and one implementation provides for the crawler 420 to store the new links in the mast link data structure 435.

The analyzer 410 may implement the gallery determination process 320 (FIG. 3) in order to generate and store information in an index 450 that identifies galleries and media objects that comprise such galleries. This information may include data to identify galleries and their individual media objects, information to enable subsequent location or retrieval of the gallery or its media objects, copies or renditions (e.g. miniaturized or reduced versions) of media objects in the gallery, and descriptive information about the gallery (key words, title, category information).

According to an embodiment, an indexing component may be used to improve or supplement information stored in the index 450. In one implementation, the indexing components 450 may (i) count the number of times a given page is linked and by which other page(s), (ii) identify authorities for a particular subject, and (iii) determine associations between network resources that contain media objects of galleries and identified authorities. As described with an embodiment of FIG. 3, this information may be used to rank or determine relevancy of a given gallery to a key word or search term or other selection criteria.

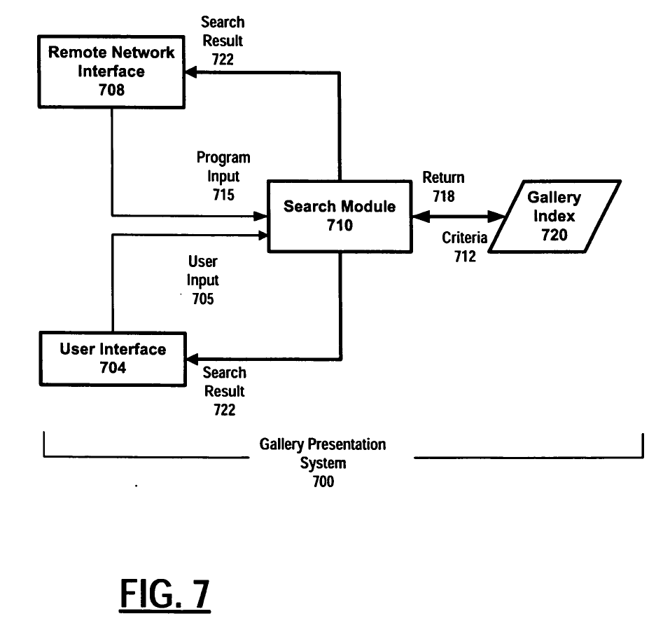

As described with an embodiment of FIG. 7, one or more interfaces or components may be provided with the gallery index 450 in order to enable search or selection processes that yield presentations of gallery renditions.

FIG. 5 illustrates more details of a system architecture such as shown and described with FIG. 4, according to an embodiment. The system 400 uses an operative combination of modules that include the analyzer 410 and the crawler 420. In an embodiment, the crawler 420 includes components for both targeted and non-targeted retrievals of network resources, such as web pages. For non-targeted retrievals, crawler 420 may access links 506 stored a seed data structure 505. The crawler 420 may include a seed selector 510 that retrieves links 506 based on criteria such as whether the link has ever been crawled before, whether a sufficient amount of time has passed since the last time the network resource located by the link was processed, whether the link has a certain level of popularity of authority, or whether the site or location identified by the link is known to include galleries or links of value. To this end, seed data structure 505 may maintain information that includes seed URLs, and dates when individual seed URLs were last used. The selected URL 506 may be made part of the queue list 515 and subjected to a fetch (or access) operation (or ‘fetchers’) 520 of the crawler 420. The crawler 420 may maintain and operate numerous instances of fetcher 520 for performing both targeted and non-targeted (i.e. with use of seed links) retrievals. As will be described, the queue list 515 may maintain targeted links 508 or URLs that correspond to targeted requests for network resources. Such links may be generated as one processing output of the analyzer 410 (along with new links for non-targeted access). Each instance of the fetcher 520 uses individual links 506, 508 stored in the queue list 515 to access network resources 525 stored therein. Network resources 525 may be retrieved for analyzer 410.

The analyzer 410 may integrate or couple with the crawler 420 to receive the retrieved network resources. The analyzer 510 may incorporate or use modules or components that include a parser 530 and a gallery determinator 540. The parsers 530 processes the network resource 525 retrieved from the fetcher 520 of the crawler 420. The functions of the parser 530 includes extracting data items from the retrieved network resource 525. For each network resource 525, the extracted data items may include text, media objects, programmatic and/or executable structures or scripts, binary objects, and links.

Resulting parsed data 545 may be cached or held for gallery determinator 540. The gallery determinator 540 may perform processes for identifying galleries and media objects that comprise the galleries. Such processes include those described with other embodiments, including embodiments of FIG. 3 and FIG. 6B or FIG. 6C. Output from gallery determinators 540 include (i) gallery information 552, including information for identifying galleries and enabling location or retrieval of media objects that comprise the gallery, (ii) non-targeted or requested links 555, and (iii) targeted or requested links 557. In one embodiment, the links 555, 557 include all links located by the gallery determinator 540. The gallery information 552 may stored in the index 550. The new links 555 may be processed by a separate link manager 572, which may be configured to (i) detect whether a link is new or previously undetected (“new links 574”), (ii) count the number of times a link occurs. The link manager 572 may use memory resources 573 to record information about links, including information about inlinks, the link-counts (e.g. number of times link is referenced by other pages), hypertext/hypermedia objects (e.g. text and other page/presentation elements included in the inlinks) provided with links, the linking page/presentation location/address, subject and tag and keyword information for each linking page and for each inlink (because linking pages can have multiple links with different associated text and elements), and other information for determining community relationships, authorities, and popularity. If the link is new, then it may be added to the seed data structure 505. The number of times that a link is detected may correspond to a count of the number of times a particular network resource is linked by another network resource. As described above, this information may be subsequently used to determine the level of authority a given network resource has. The requested or targeted links 557 may be identified as a result of an iterative or hunt process in which the gallery determinator 540 seeks constituents of a gallery when clues or markers of a gallery are detected (see FIG. 6A thru FIG. 6C). With regard to authorities, one or more embodiments provide that authorities are identified for communities in an online environment, such as communities for a particular subject matter. An embodiment may recognize communities related to certain subject in networks. Such recognition of communities may be determined algorithmically, or through manually determined information by operators of a site. Within identified communities, one or more embodiments recognize the authorities. The authorities may correspond to a site, a page, a segment (entry or blog entry), or a person or personna, or other identifiable instance of an online entity. Authorities linking to or communicating about network resources can be used to influence ranking (and crawling efficiency).

In an embodiment, some or all of the gallery information 552 may be subjected to processes of the indexing component 565. Indexing component 565 determines additional information about links to network resources that contain media objects. In one embodiment, the indexing component 565 also communicates with the link manager to receive link information 567, which may include data that indicates, for example, an authority level or a count as to the number of times a network resource of one of the media objects was linked to by another network resource. Maintaining such counts facilitates determinations of authority, relevancy and ranking. These determinations may be used for sorting or ranking items that are returned as part of a search result. The indexing component 565 adds index data 575 to the index 550.

In one embodiment, the gallery determinator 540 is configured to execute one or more gallery determination processes 320 (FIG. 3). This includes detecting media objects that are candidates for galleries, and then initiating the iterative or targeted retrieval and analysis process with use of fetcher 520 (or instances thereof). Accordingly, the gallery determinator 540 scans the parsed data 545 of individual retrieved network resources for data items that are markers for the presence of media objects that are candidates for galleries. In one embodiment, the markers include image elements or media objects that embedded or combined with links. Examples include image elements that are embedded with hyperlinks. However, other more functional links that embed or operate in connection with media objects or images may also be detected. Such functional links may correspond to, for example, scripts or programmatic elements (e.g. programmatic elements in the form of Macromedia Flash or Microsoft Silverlight or Adobe AIR or Mozilla Prism or Java Applets or ActiveX controls or scripts.

In executing the gallery determination processes, the determinator 540 may inspect network resources for markers or indicators of galleries. Examples of such markers include any one or more of the following: (i) a media object that is of a particular size or quality to be part of a gallery, or provided with text, other media objects or other context to indicate a general theme or category; (ii) a cascade or arrangement of media objects on one network resource; (iii) multiple media objects provided under common text heading or description; (iv) a cascade of image elements or other media objects that are of reduced size; (v) presence of certain words or phrases; (vi) image element or other media object that is embedded with a link or programmatic element to another linked network resource; or (vi) temporarily separated images that are displayed on a common area or space of a page or other resource. Numerous other markers may be identified and used over time, particularly with trends and technological advancement as to how media objects are displayed and used on web pages and other network resources. The markers may indicate the certain media objects, such as provided on the network resource or linked to the network resource of the markers, is part of a gallery. As such, an embodiment provides that the process followed by the gallery determinator 540 to identify media objects of galleries is iterative and multi-stepped.

In an embodiment, the gallery determinator 540 is capable of identifying media objects for numerous kinds of galleries, including galleries provided on various kinds of pages and/or with different kinds of media objects and context. In different cases, for example, the markers to identify candidate media objects or galleries, or the relationship of the network location of the individual media objects (e.g. gallery of media objects on sibling pages or on common page as thumbnails) and how they are identified may be varied depending on gallery type. In order to enable programmatic identification of media objects that comprise galleries, editorial criteria may be used to define gallery profiles 548. Each gallery profile may define, for example, markers of the gallery and/or its media objects, network path or location relationships amongst the media objects, layout characteristics or attributes of the media objects, and procedures to procure information and to determine from the information whether candidate media objects satisfy the editorial criteria to deem identification of a gallery or a media object of a gallery. The gallery profiles 548 or class types may be implemented as rules or other evaluation mechanisms that are processed by the gallery determinator 540 to determine whether a media object or set of media objects satisfy the editorial criteria of any particular known type of gallery. The editorial criteria or profiles may be maintained and updated by human experts, who have knowledge of trends and advancements in how galleries of media objects are presented on, for example, the World Wide Web.

FIG. 6A illustrates a method employed by the gallery determinator 540 to identify media objects that are part of a gallery, according to an embodiment. Initially, in step 610, the gallery determinator 540 is assumed to start without any media object trail for pursuit of a gallery. The gallery determinator 540 inspects the parsed data 545 of a given network resource for one or more markers of a gallery. The gallery markers may include, for example, media objects that are provided with embedded links or media objects that in and of themselves have potential to be part of a gallery (i.e. a ‘candidate’ media object). However, as mentioned above, numerous other markers may be sought and used in a method such as described, or in other methods or processes for identifying media objects of a gallery.

If a determination is made in step 615 that no such gallery marker is located on the given network resource, data parsed from another network resource is retrieved in step 620, and step 610 is repeated. If however, the determination is made that the gallery marker exists, the step 630 initiates an iterative or multi-step trail or hunt to locate media objects of the gallery. Depending on the type of marker identified, the trail or hunt may follow different steps. These may be based on which gallery class types are still an option at each step of the process. The most efficient route through the decision tree (in terms of number of comparative or analytic steps) is deduced based on the total set of editorial criteria, all existing checks that can be performed during analysis of each gallery type, and the density of occurrence of each gallery type. Hence the shortest or most efficient route can change based on the extension or change of the editorial criteria and the gallery types that are included for detection. As part of the iterative/hunt process, the gallery determinator 540 may request links 557 for targeted network resources, in order to find media objects distributed over a cluster of linked network resources. Rules 541 provided from one or more of the gallery profiles 548 may control steps followed, depending on the type of marker or media object located.

FIG. 6B illustrates a first kind of trail or hunt for media objects of a gallery. FIG. 6C illustrate a second kind trail or hunt for media objects of a gallery. Each hunt sequence or process may be implemented concurrently, with other hunt sequences to accommodate the dynamic nature of the network environment and the creative manner in which galleries may be created or presented. Numerous other trails or multi-stepped process may be performed to identify, from presence of certain markers, the contents of image galleries. The data and internal results of the process can be shared to accommodate or strengthen further analysis.

With regard to FIG. 6B, Step 631 provides that identifying the gallery marker may correspond to detecting a media object from on a network resource, such as an image file, that has characteristics (e.g. size, quality) of a media object for a gallery. The media object may be identified by the gallery determinator 540 from inspection of parsed data 545 extracted from a cached network resource (procured from fetcher 520). Such a media object may be termed a ‘candidate’ media object. If the marker corresponds to identification of a candidate media object, step 632 provides that the gallery determinator 540 checks the same network resource (from the parsed data) for other candidate media objects. If other media objects are found on the network resource in step 635, nexus information pertaining to the found media objects is recorded in step 638. The nexus information may include contextual information that can be used to identify a theme or category or context for the retrieved media objects. For example, editorial criteria that defines a gallery may require that images are deemed to be part of a gallery when they share some key word, category, theme or context. The nexus information may be recorded from surrounding text of the identified media objects, the title under which one or all media objects are found, the title or name included in the site where the media objects are provided (e.g. the name of the domain specified in the URL), captions provided with media objects, positioning of captions provided with media objects, or other data or information. The nexus information may also extend to metadata, such as the date or creation of a media object or its author.

Step 640 provides that the identified media object is added to a set. Step 632 may be checked again to determine whether another candidate media object is provided on the common source. The presence of numerous image files, for example, when provided on one page, may signal the presence of a ‘gallery page’ (or presentation). The gallery page is a page that displays multiple images in the form of a gallery. However, galleries are often tiered or inter-linked. If no other media objects are found on the network resource as a result of step 635, step 644 checks the network resource for links, particularly links that have indicators for having relevance to recently found media objects of a set in formation. Relevant links may include those that are positioned near previously identified media object, or are incorporated with text or tags that are shared by links or data of recently detected media objects. Such related links may, for example, be (i) embedded with image elements or media objects, or (ii) provided in proximity or with the candidate media object.

As an addition or alternative, step 644 may be performed independently of step 632 in order to identify potentially related links from the network resource under analysis. If in step 646, the gallery determinator 540 does locate another link, it records ‘proximity data’ about the identified link in step 647. The proximity data refers to data that identifies the relationship between the link or its network resource and other links of media objects identified as candidates for a common gallery. As will be described, the proximity data may be used to weigh whether a subsequently found media object is to be deemed part of a gallery with other media objects, or whether a media object or network resource should be disqualified as being too far removed from the found media objects. Rules 541 of the gallery profiles 548 may dictate whether the proximity data is in favor or against media objects of the network resource identified by a link being considered part of a larger gallery of media objects. In step 648, a determination may be made as to whether the relationship of the identified link disqualifies it as being a potential locator for a network resource that can provide another media object for a gallery. If the identified link has potential to locate another media object that is a candidate for a gallery under identification, the step 650 provides that the link is accessed and used. In one embodiment, the gallery determinator 540 submits the link request to the fetcher 520, which retrieves (i.e. performs a targeted retrieval) of the network resource 525 that is identified by the link (the ‘linked network resource’). The parser 530 parses the linked network resource 525.

In the case where a determination is made (step 652) that the identified link is embedded with media or an image element, the underlying image element to the linked media is identified if possible in step 653(see method of FIG. 6C). Step 638 may follow (identification of nexus information). As an alternative or addition, a non-media link may be handled by step 632, meaning the network resource retrieval process is initiated again, using fetcher 520 and the parser 530.

With regard to an embodiment of FIG. 6B, at some point when some or all of the media objects that are to comprise the gallery under consideration are identified (step 640) evaluation (step 655) against editorial criteria that defines galleries (by type) may result in a conclusion that some or all of the candidate media objects for the gallery under consideration are deemed to be (or not to be) part of a gallery. In an embodiment shown by FIG. 6B, step 655 follows conclusion of identification of some or all media objects and all related links in a hunt that started with an initial network resource. In this regard, the rules 541 that define gallery types may be used to determine whether a given gallery is deemed present for a cluster of identified media objects.

In FIG. 6C, the hunt sequence is implemented based on a gallery marker that corresponds to a media or image element (or object) that is embedded with a link. As mentioned elsewhere, one common type of gallery is provided by a cascade or presentation of thumbnails (or other small media or image elements), each of which are embedded with a link that opens a corresponding page where a larger or more full version of the same image element is provided. In such a presentation, the thumbnail presentation may serve as the marker to the gallery. The underlying media objects that each thumbnail opens or represents may also constitute one of the media objects of the gallery.

In step 650, the gallery determinator 540 detects, from inspecting parsed data from a given network resource, a gallery marker in the form of an image element embedded with a link. As mentioned above, the link may correspond to a hyperlink, script segment or other programmatic element. The image element of the link combination is analyzed in step 655 to determine its attributes or characteristics.

In step 660, the link provided with the image element is identified and then processed. In an embodiment such as shown in FIG. 5, the gallery determinator 540 requests link 557 for the fetcher 520 to process. The fetcher 520 retrieves a network resource located by the link and the parser 530 parses the resource. The parsed data may be held in cache for use by the gallery determinator 540. In step 665, the underlying or corresponding media object to the image element of the embedded link is identified. This may include sub-steps of identifying characteristics and attributes of each media object in the newly accessed network resource. The underlying media object be assumed to have some of the same characteristics as the image element of the embedded link, such as the same aspect-ratio or color characteristic over some or all of the image element.

According to one embodiment, step 670 provides that nexus data is recorded. The nexus data may correspond to contextual data that can subsequently be used to determine whether media objects in a set share a common contextual characteristic for satisfying an editorial criteria of being considered a gallery.

In step 675, the media object may be identified as part of a set. In step 678, the network resource containing the embedded image element link may be inspected for another media object. If another embedded image element is found in step 682, the method for the identified embedded image element is repeated with step 655. At any point when there are enough media objects in the set, step 686 provides that one or both of (i) the set as a whole, or (ii) individual media objects in the set are evaluated against the editorial criteria (as specified by profiles 545 and rules 541). The criteria may include (i) proximity component and (ii) nexus component. In one implementation, the media objects in the set are presumed to be part of a gallery as they have strong proximity (share common source). In another implementation, the nexus component may factor in. For example, key words surrounding or provided with an image, positioning of an image, presence of text caption or is layout, or the title or heading of the individual media objects may be used to determine whether the editorial criteria is satisfied for considering the set of media objects a gallery. Alternatively, the criteria may select some but not all the media objects for a gallery. Still further, more than one gallery may be identified, and the multiple galleries may share some media objects but not others. Numerous variations for determining presence of galleries may be used.

FIG. 6B and FIG. 6C illustrate two possible hunt sequences in which the fetcher 520 may be utilized by an analysis component or module such as the gallery determinator 540. For example, an embodiment of FIG. 6C encompasses a scenario in which a cascade or presentation of thumbnails is presented, with links to underlying images that collectively form a gallery. As mentioned, the gallery profiles or rules may be updated routinely to follow trends or advancement in the manner in which media objects are bundled or presented as galleries. Criteria may be adjusted as needed to enable programmatic determinations of the existence of galleries better match that of human judgement.

As described with embodiments of FIG. 5 and FIG. 6A thru FIG. 6C, gallery determinator 540 scans the parsed data 545 for media objects. As embodiments described herein provide that the gallery determinator 540 operates on multiple network resources and follows multiple trails to identify numerous galleries at one time, the targeted access of network resources, parsing and media object inspection performed by the gallery determinator 540 on successive steps may be performed asynchronously, using cache, for example, to hold the parsed data 545.

Gallery Types

Gallery profiles may dictate rules (including conditions or weights) for employing iterative or hunt processes, based on characterizations made by human experts as to trends in the manner galleries are found on the World Wide Web or on a local network. The profiles may each accommodate conditions or criteria that are representative of corresponding profiles. Specific examples of profiles that may be represented by gallery profiles 548 include but are not limited to:
(1) Thumbnail—source page image gallery. This type of gallery includes one main gallery page containing a collection of thumbnails. Each thumbnail links to a new page with a larger version of that image (i.e. the underlying media object). In many instances, such galleries are implemented as HTML web pages or web presentations.
(2) Thumbnail—source page video gallery. This type of gallery includes a collection of thumbnails, which are screenshots of videos. Each thumbnail links to a page with a corresponding video or portion thereof.
(3) Thumbnail—source image gallery. This type of gallery includes one main gallery page containing a collection of thumbnails. Each thumbnail links directly to a larger version of that image
(4) Thumbnail—source video gallery. A gallery with one main gallery page containing a collection of thumbnails, which are screenshots of videos. Each thumbnail links directly to the video.
(5) Thumbnail—source page gallery with thumbnails on each page. A gallery type that is to other thumbnail galleries, with the addition that each source page contains all thumbnails again.
(6) Single page gallery. This type of gallery includes a page with one large photo and the collection of thumbnails.
(7) Slideshow with thumbnails. A gallery with that provides a slide show with thumbnails which a user can use to navigate through the slides.
(8) Slideshow without thumbs. This gallery includes a slide show without thumbs for navigation (but might have other navigation options)
(9) Slideshow with thumbnails start page-This gallery is the same as a slideshow with thumbs, but with a main gallery page that contains all thumbnails.

While galleries are often implemented with HTML, many of the galleries described herein may incorporate code as Flash, Adobe AIR, Microsoft Silverlight, Mozilla Prism, Active X controls, Java Applets, DHTML or other similar dynamic formats.

An embodiment provides for use of vertical or directed crawling in which the crawler 520 (FIG. 5) processes a ‘string’ of network resources to detect and analyze a gallery that hierarchically is organized over multiple levels, for purpose of identifying galleries that are adjacent, or part of the same parent, or part of the same sub-tree. Additionally, these galleries can be compared to deduce important relevancy and other information.

For example, when a site (or sub-site) has three travel galleries in a section of a site that deals with travel galleries, and the destinations correspond to Thailand, Turkey, and Aruba, information that indicates differences amongst the galleries may have significance. For example, when the title of a gallery is something like: ‘Wild Bills traveling photo's: Thailand’ or ‘Wild Bills traveling photo's: Turkey’ or ‘Wild Bills traveling photo's: Aruba’, the words that are different, ‘Thailand’, ‘Turkey’, and ‘Aruba’ provide significant clues that are relatively unique for each gallery. These clues can be provided as descriptive information, such as labels, for use in returning results for search operations. Such analysis may also recognize that one instance of a word can be ignored or almost ignored while another instance of the same word is very important.

Similar processes may apply to navigation menu's. Each of the tree galleries in the example provided may include a link to one or both of the other galleries and therefore each of the galleries will include and match with all three words: Thailand, Turkey, and Aruba (even though only one of the words is of real relevance for a gallery). Search operations of matching or ranking may be enhanced with use of information derived from comparisons of such galleries, particularly as to relevance and/or meaning of individual instance of tokens/words.

An embodiment such as described in preceding paragraphs compares galleries or sub-galleries or pages that are relatively close from each other in network location. The results may better simulate human judgment as to how individuals would consider images at closely related network locations being part of different galleries.

Additionally, layout features may form part of the analysis. Also, a relative ‘fingerprint’ of the page or of the text and layout of a page can be used during this process too to compare if galleries/pages are relatively similar.

Categorization

With further reference to FIG. 5, or more embodiments provide that the gallery determinator 540 includes or operates in conjunction with a categorizer 590 that analyzes the parsed network resource data 545 for network resources that contain the media objects of identified galleries. According to an embodiment, the categorizer determines a relevance of a media object or gallery to a particular label, such as a key word or category description. In order to determine labels and relevancy, the categorizer 590 may scan and analyze text and other data contained in the network resource of individual media objects. In one embodiment, the categorizer 590 may scan for titles, key words, URL terms, captions, or metadata in order to determine labels or other descriptive information. In particular, the categorizer 590 may assign categories, search terms, descriptive text or other information for use in enabling search of the identified galleries.

In an embodiment, labels or descriptive terms include key words appearing in titles or headers of gallery pages. Other descriptive terms may be determined by identifying key words. Key words may be assigned more or less relevancy based on the number of times the key words appear with the gallery or media object.

In addition to text appearing with the gallery or media object, other data may be used to determine the relevancy of a particular gallery of media object to a label, category or descriptive term. The popularity of the page or network resource may reinforce relevancy of key words. Data such as provided by breadcrumbs or navigation history of visitors to a web page may also facilitate what labels are relevant to a particular media object or gallery. For example, visitors that link from a travel site are may make it more likely that geographic key words in the text of the page are relevant to the gallery's media objects.

Still further, relevance may be determined from parameters such as the type of page or network resource that provides a media object. For example, categorizer 590 may assign more importance to words when they appear in a photogallery type page, for example, than when they appear in a photojournal or blog.

Still further, the categorizer 590 may also employ use of comment sections in network resources in order to determine labels and relevancy of label terms. The categorizer 590 may be configured to detect comments and to analyze comments for labels or descriptive terms. Comments may be given more or less weight based on, for example, the number of unique posters that provide the comments.

Search with Selection Criteria

As described with an embodiment of FIG. 5, an index or other data structure may be used to enable gallery presentations to be created from a search or selection engine. FIG. 7 illustrates a system for creating presentations of images that comprise a gallery in response to submission of a selection criteria, according to an embodiment. The system may leverage or otherwise use gallery information and determination provided from other embodiments described herein (e.g. such as with an embodiment of FIG. 5). According to an embodiment, a gallery presentation system 700 includes a search module 710 that compares selection criteria 712 against information contained in an index 720 of gallery information.

The index 720 may include data or information that identifies the location of individual media objects that comprise the gallery. In one implementation, the information includes URLs or other location information. The index 720 may also store renditions or copies of the media objects that comprise the gallery. In the case of image files, for example, the index may store thumbnails or reduced sized images. In the case of video clips, thumbnail or still shot of a scene of the video clip may be stored. Additionally, the index 720 may store descriptive information, such as labels. As described above, the index 720 of gallery information may also include text descriptions that correspond to programmatically identified or determined information about galleries of media objects. These text descriptions may include labels or category descriptions, as well as data that, for example, indicates the relevancy of individual labels or search terms to the gallery. The relevancy data may be used to determine a relevancy score for a particular criteria 712. Some ranking or relevancy data may be also be maintained with the index 720 in order to facilitate future rankings, authority determination or relevancy determination.

According to an embodiment, the search module 710 may couple to either a user interface 704 or a programmatic selection component 708. The user interface 704 may be provided in the form of search field that is hosted at a network site of a search engine. The user may interact with the user interface 704 to provide input 705. In one embodiment, for example, the user interface 704 may correspond to a web page that displays a search box, menu field or other text entry field. The user may specify a search criteria by entering a word or phrase of interest. The user interface 704 may convert this interaction from the user into criteria 712. The search module 710 may compare the criteria 712 to key words, labels or descriptive terms in the index 720 to identify a search result 722. The search result 722 may be returned or otherwise identified to the user interface 704

In one embodiment, the programmatic selection component 708 includes triggers or other programmatic elements that reside on a page or network resource of another location. The triggers may be activated with some event, like a page download or viewing. The triggers may control or specify data 715 that are interpreted or otherwise correspond to criteria 712. The search module 710 may compare the criteria 712 to the text information in the index 720 to identify matching entries as part of return 718. The matching entries may be configured according to rankings of individual entries, and outputted from the search module 710 as a search result 722. The search result 722 may be returned or rendered to the network resource of the programmatic selection component 708, or to a network location specified or used by the component.

According to an embodiment, each entry of search result 722 includes a rendering of a set of images that correspond to a gallery of media objects. The images may be commonly or individually linked to media objects of the identified gallery. Other information, such as the gallery page (e.g. common parent page to gallery images), title or descriptive information may be provided in some form as part of the entry. Numerous entries may be provided as part of the search result 722.

Given that the number of entries that match a given criteria 712 may be numerous, search module 710 may employ algorithms to rank, sort and/or filter entries from the search result. In an embodiment, the search module 710 is configured to use (i) relevance score, (ii) page ranking, and (iii) authority-based parameters. Relevance score may be determined in part by key word analysis, including by identifying unique words on a page or resource containing a media object or gallery, the number of words used in the context of the media object(s) or gallery, the title of the page or resource of the gallery page or its objects, analysis of comments or pages that link to the resource or page where the gallery or media objects is presented.

Page ranking refers to algorithms that count the number of links that point to a site, page or network resource. Various page ranking algorithms exist that weigh various parameters. These include use of quality parameters, which take into account the type of site that provides links to a particular network resource (containing a gallery or one of the media objects of the gallery). In another variation, page ranking values may be determined for sites based on subjects or categories. For example, a travel site may have a much higher page rank score for the subject of ‘travel’, rather than compared to all sites on the web. In one implementation, a gallery that matches or is otherwise highly relevant to a selection criteria may rank higher than a another gallery with similar relevance based on the respective page count values determined for the site or location of each respective gallery.

Authority parameters are based on identification of sites that can be considered ‘authorities’ for a particular community or subject matter. Authority sites may be determined from human input, inlink ranking or popularity, the number of links provided on a particular site or page, the number of hits or views it receives or other parameters like amount and quality of comments and discussion on the site or page or on a site or page linking or referring to the site or page. A gallery from a site or a page that is considered an authority of a topic or subject matter that is highly relevant to the search term may score higher in terms of ranking of that topic or subject matter. Additionally, a gallery that is linked to by an authority site may receive a higher ranking.

Presentation

Embodiments described herein enable display of presentations that comprise renderings of galleries identified at various network locations on the World Wide Web. According to an embodiment, a presentation comprising a rendering of one or more galleries may be displayed as a search result. According to another embodiment, a presentation comprising renderings of one or more galleries may be provided as a web publishing tool to enable content providers ability to display visual and criteria-based media objects. Other applications for displaying presentations that include rendering of galleries may also be provided.

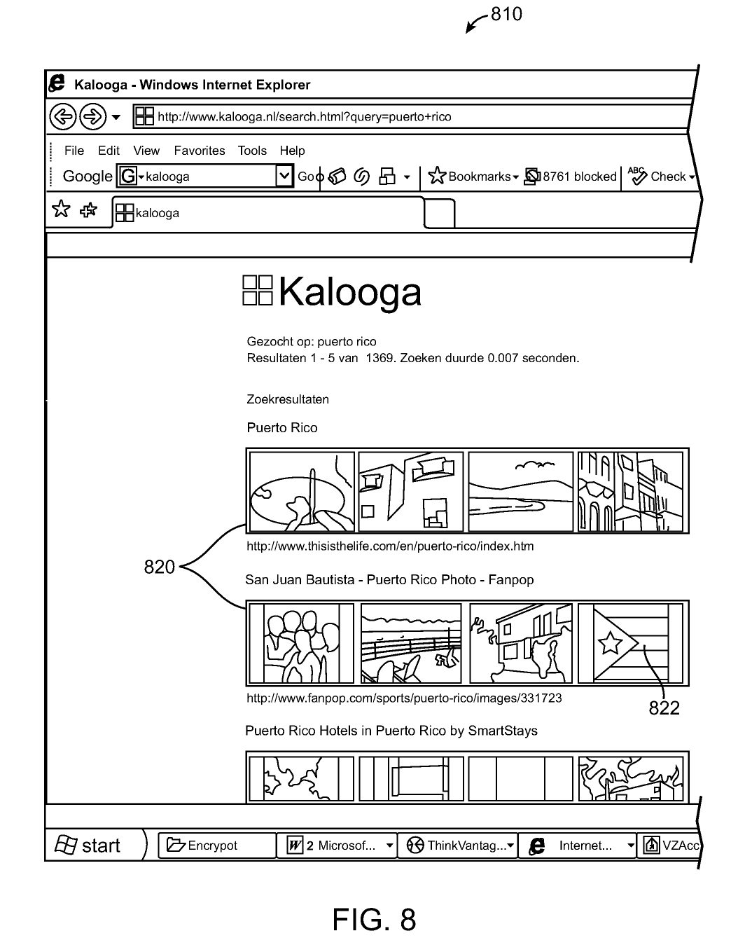

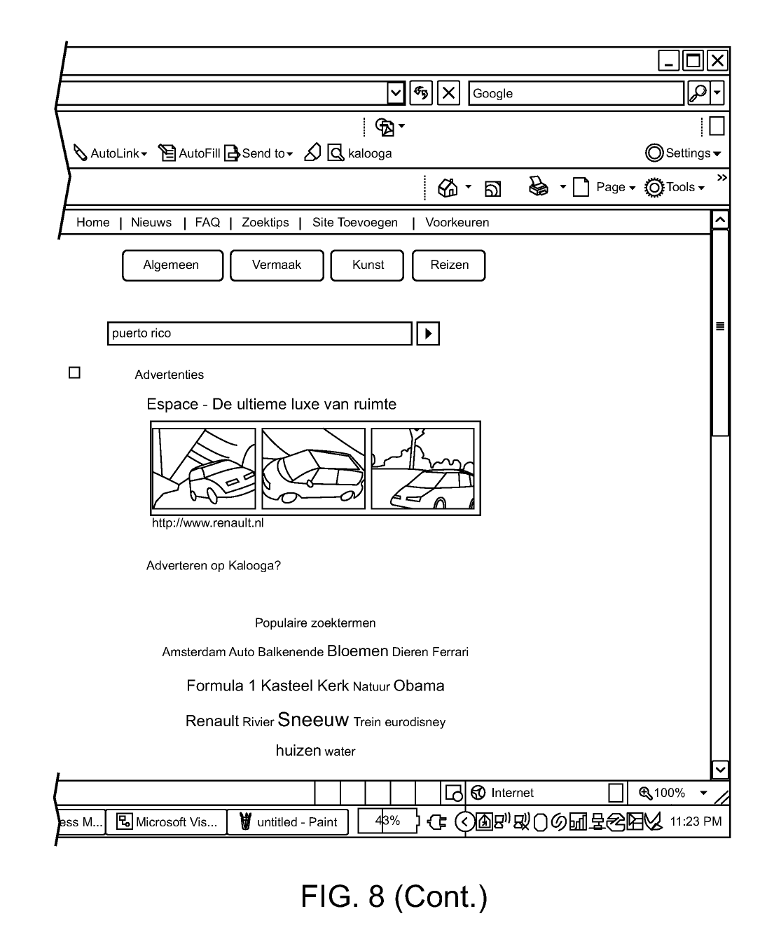

FIG. 8 illustrates a presentation that may be generated from a site and displayed to a user via a web browser, under an embodiment of the invention. The presentation 810 includes a plurality of gallery renditions 820, where each gallery rendition 820 represents a corresponding gallery identified in, for example, a gallery index (such as gallery index 450 in FIG. 4). Each gallery rendition 820 includes a compilation of images 822 that are renditions of the various media objects that comprise the gallery. In an embodiment, the images are reduced in size or dimension, or otherwise altered to reduce data size. While a gallery being represented by each of the gallery renditions 820 may include numerous media objects, including media objects that are thumbnails and full scale, a limited or smaller set of media objects may be displayed due to limited available display area. As such, an implementation such as shown by FIG. 8 provides that individual gallery renditions 820 display only a portion of the overall media objects that comprise the represented gallery.

In an embodiment, elements of the individual gallery renditions 820 are activatable. A user may select a portion of a gallery rendition, such as an image element 822, to access the corresponding gallery page (e.g. the main page where most of the media objects are displayed, thumbnail-represented or otherwise made accessible or preview-able) for the represented gallery. As an alternative or addition, the image elements 822 or other portions of the gallery rendition 820 may be selectable to access a thumbnail or full size version of one of the media objects that comprise the represented gallery.

In the case where the presentation 810 corresponds to a search result, or otherwise based on selection criteria, the gallery renditions 820 may be ranked by relevance and other parameters such as described above. Additionally, a user's selection of an entry in the gallery rendition may be recorded or used at a later time to determine future rankings.

With further reference to an embodiment of FIG. 8, numerous refinements to the manner in which the gallery renditions are displayed may made. Such refinements may be made to, for example, components of a system such as described in FIG. 7. According to one embodiment, the sequence or order in which thumbnails are displayed in a given search result may be based on how well each image of the thumbnail is deemed to match the selection criteria.

Still further, an embodiment may track or otherwise record when sites were crawled, so that most recently crawled sites are favored to be ranked higher, or further on top.

Still further, an embodiment provides that the user interface 704 (FIG. 7) or search module 710 (FIG. 7) monitors a ratio of the amount of impressions for each result and the amount of clicks on the result for each query (click-through ratio per displayed result). Renditions in results that have low click through ratios (for certain queries) may be altered in ranking for that query. Likewise, renditions in results that have high click through ratios may be favorably altered in the ordering or sequencing of the result.

An embodiment provides that the user interface 704 (FIG. 7) or search module 710 (FIG. 7) monitor the ratio between the amount of impressions of each image/thumbnail within each result and the amount of clicks on the each image/thumbnail for each query (click-through ration per displayed image/thumbnail). Similar to altering the rank for results related to a certain query, an embodiment enables the rank of thumbnails within a rendition for a certain query to be altered in sequence (or removed from display). Next to the high ranking images at the beginning of each result, one or more embodiments provide for rotating the other images at the end of a result until a sufficient amount of impressions is met to make sure all images have been ranked using click through ratio for a certain query.

Sponsorship

According to an embodiment, the gallery presentation 810 may also be used to display sponsored or paid galleries, gallery renditions or simulations. In one embodiment, sponsors may upload sponsored galleries of media objects into an index or similar system, such as described with any of the embodiments described above. Alternatively, sponsors can let an embodiment as described above aggregate, analyze, retrieve, and present their existing galleries by providing the location/URL of the gallery, after which the sponsor can then edit and customize the final presentation of the rendition to tune it for sponsoring usage. The sponsors may correspond to entities or persons who pay to have links displayed with gallery renditions on, for example, a search page containing search results generated for a user. In this regard, the sponsors may specify labels or key words from which their sponsored links may be displayed. As shown by an embodiment of FIG. 8, the sponsored links may be embedded with image elements, so as to simulate, or alternatively represent, a gallery of media objects. In one embodiment, the sponsored links may simulate a gallery, in that the sponsor may include image elements that are thumbnails and not representative of an existing gallery on an external site. The thumbnails may be ‘for show’ to provide a consistent image or feel with the search results. The image elements may be combined, embedded or otherwise provided with links to a site that the sponsor wants the user to see. Alternatively, commercial content, such as in the form of advertisement or promotions, may be displayed to the user when the user selects a sponsored link, or alternatively hovers a pointer over the sponsors links.

Alternatively, the sponsor may upload or otherwise specify URLs that are combined with the image elements of the sponsored links. Individual links may be selected by the user to view underlying portions of galleries, whether provided as video clips, large media objects, thumbnails, Flash or other programmatic and/or scripted elements. The underlying portions of the galleries themselves may be part of an advertisement campaign, for example, so the images may represent or be provided with commercial material and/or links. Numerous variations to the manner in which sponsored links, combined with gallery renditions or simulations, and/or underlying media objects and elements, may be combined with commercial content, including promotions and advertisements.

Embodiments described herein enable commercialization of presentations that display renditions of galleries, such as in connection with search engine type or other publication and portal services. In an embodiment, a sponsorship or advertisement feature may be implemented in a search engine implementation, such as described with an embodiment of FIG. 7 (with combination of user interface 704 and search module 710). The advertisement feature offers sponsors and advertisers a self-service method of creating and maintaining advertisement campaigns (currently using a web-interface). Such a feature may enable sponsors or advertisers to create and manage commercial campaigns with use of sponsored media object presentation search results (like sponsored image gallery search results). Access by sponsors may be provided manually, or programmatically, through use of an application program interface that enables programmatic access. Programmatic access in particular may enable sponsoring parties to let their own advertisement managing software interact and specify campaigns. In general, the campaigns may display media objects such as images that are selected by sponsors to generate interest in a product or service or site. The media objects may, for example, include advertisement, or display content that is of interest to individuals who maybe searching for a particular type of gallery. In the latter case, the images promoted by the sponsor may, at least on their face, be non-commercial, but the interest caused in displaying the media objects (along with text or other contextual items) may direct the user to a particular site or location that is of benefit to the sponsor.

Accordingly, one or more embodiments enable and support a visual type search advertising that enables sponsored links or media objects without distracting the user of gallery renditions that are of focus. In one embodiment, presentations are generated that combine ‘organic’ search results (those that are not sponsored) with gallery renditions that are sponsored. In this way, sponsored gallery search result may enable a visual ‘analogy’ of well-known search advertising using a combination of text-based tags and/or contextual advertising.

One or more embodiments provide that during the process of advertising or campaigning promotions, sponsors can choose to select audiences in multiple ways. Functionality that is similar to advertisement functionality typically offered by third-party systems includes Pay-Per-Click keyword bidding functionality, geo-targeting and channel/resource (‘origin/referrer’ of a visitor) selection functionality. The ‘origin/referrer’ of the visitor depends on the method and channel of publishing of the advertisement and covers the origin/site where visitors are now (contextual advertising) or came from (search/portal advertising) before they were displayed the advertisement.

Embodiments recognize the beneficial visual aspect of displaying sponsored media objects in presentations of search results with gallery renderings (e.g. displaying some of the media objects that comprise the gallery as a cluster of thumbnails). The presentation aspects and the user interaction may be analyzed for sponsors in order to improve the performance of their campaigns. According to one embodiment, presentation aspects allow sponsors to specify different destination targets for each cluster or individual media object rendering that the advertiser specifies. For example, under one implementation, sponsors may address dynamic elements of their website using a target-link (calling a script from inside link), the result of a user selecting a certain visual preview element from a set of multiple within a sponsored search result can be a customized webpage. This allows the advertiser to provide the user with a page that is tuned to be extra relevant to the visual preview selected by the user. If the visual previews included in the sponsored search result cover different subjects, the pages that are displayed as a result of the user selecting the different visual previews can reflect these subjects accordingly. This mechanism allows for further tracking of performance of advertisements and advertisement configurations.

Furthermore, the approach of including multiple visual previews in a sponsored search result includes inherent optimization aspects. By allowing advertisers to include several visual previews, the ratio between the amount of impressions of each visual preview and the amount of clicks on each visual preview can be used to select those visual previews that result in higher click-through ratios. Attributes that can be used in this selection process are keywords used to search (or relevant contextual keywords), geo-location of the user, origin/referrer of the user, or other user attributes etc. Certain visual previews might be selected more often or less often by certain groups of users that might be related by keywords searched, geo-location, originating source/site, etc. For example, by showing different images to users originating from a teen-site than to users originating from a senior citizens site can help increasing the click-through performance of advertisements (for example the visual previews of sponsored results for certain travel destinations). By reporting the selection behaviour of users to the advertiser, advertisers can be offered further insight into the behaviour of their target audiences, which can help them to optimize their advertisement campaigns.

Sponsorship Tools and Interfaces

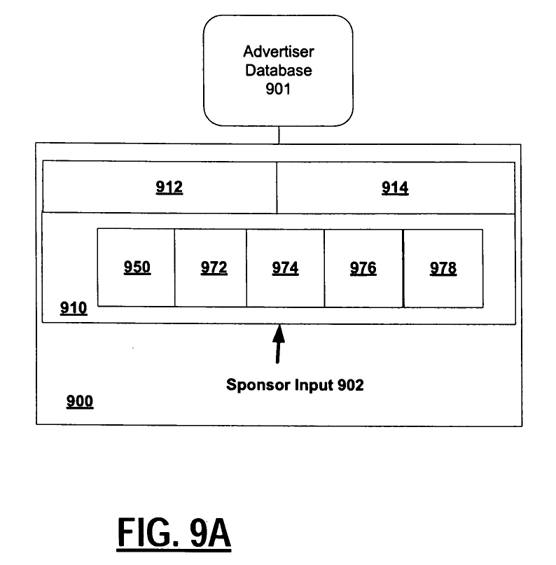

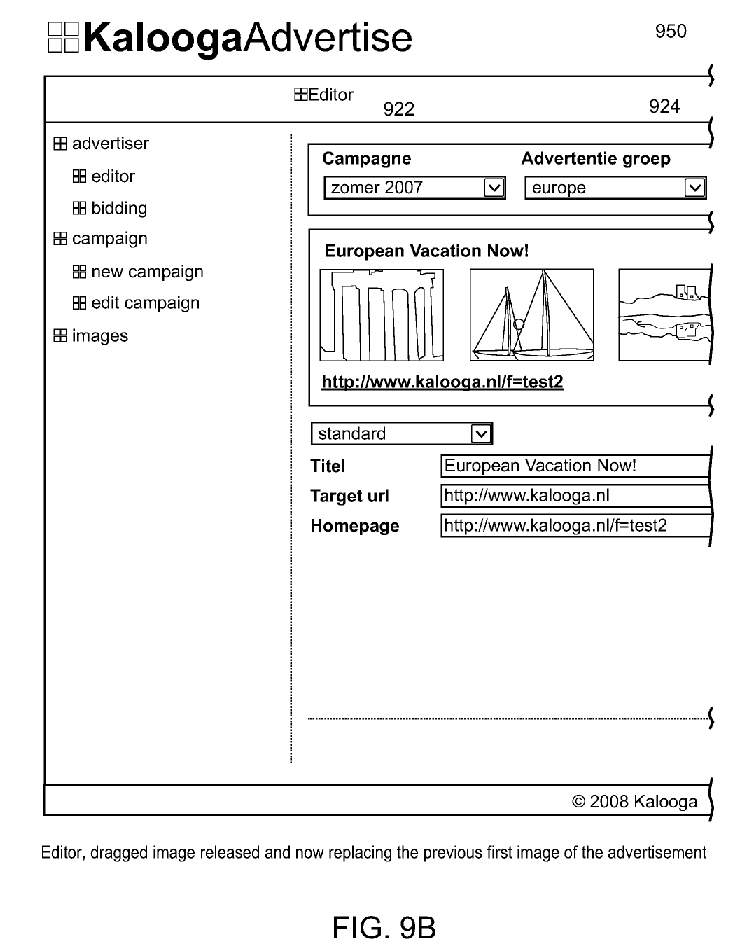

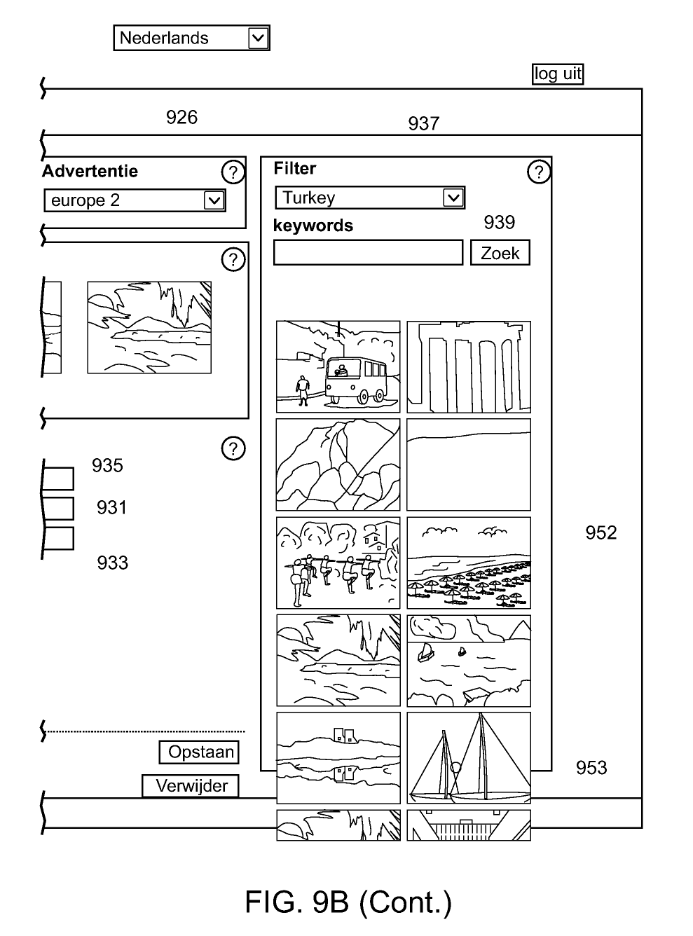

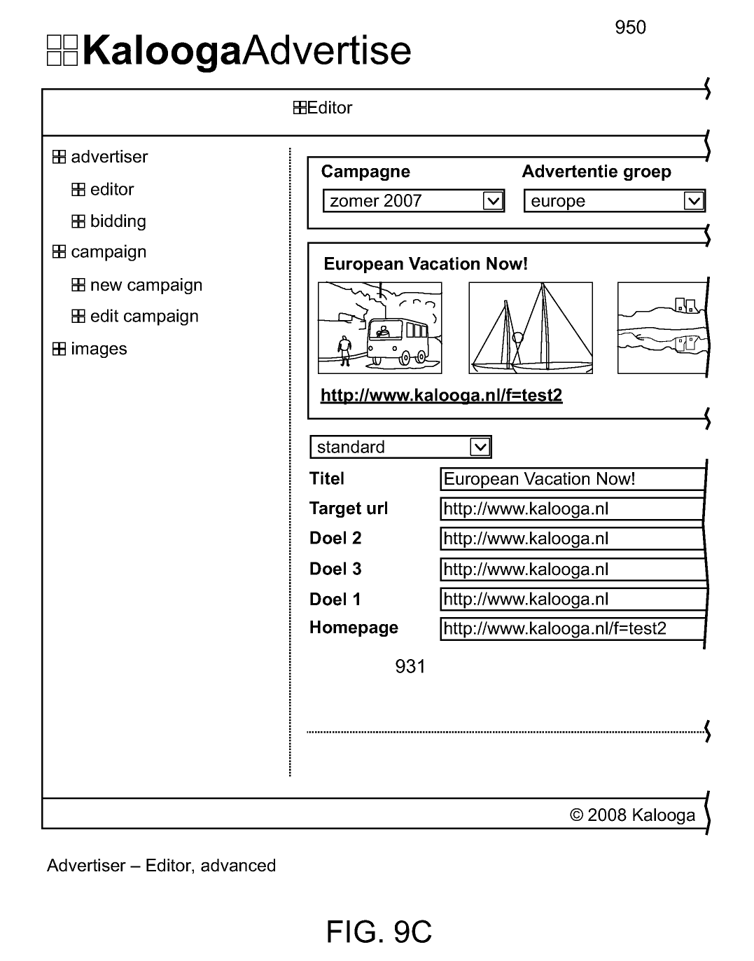

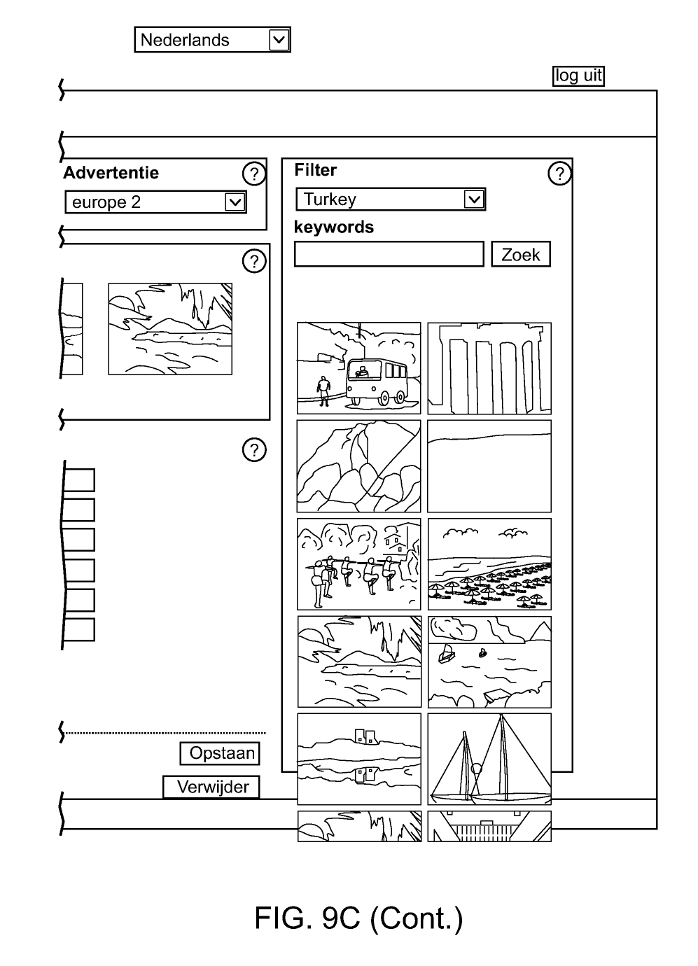

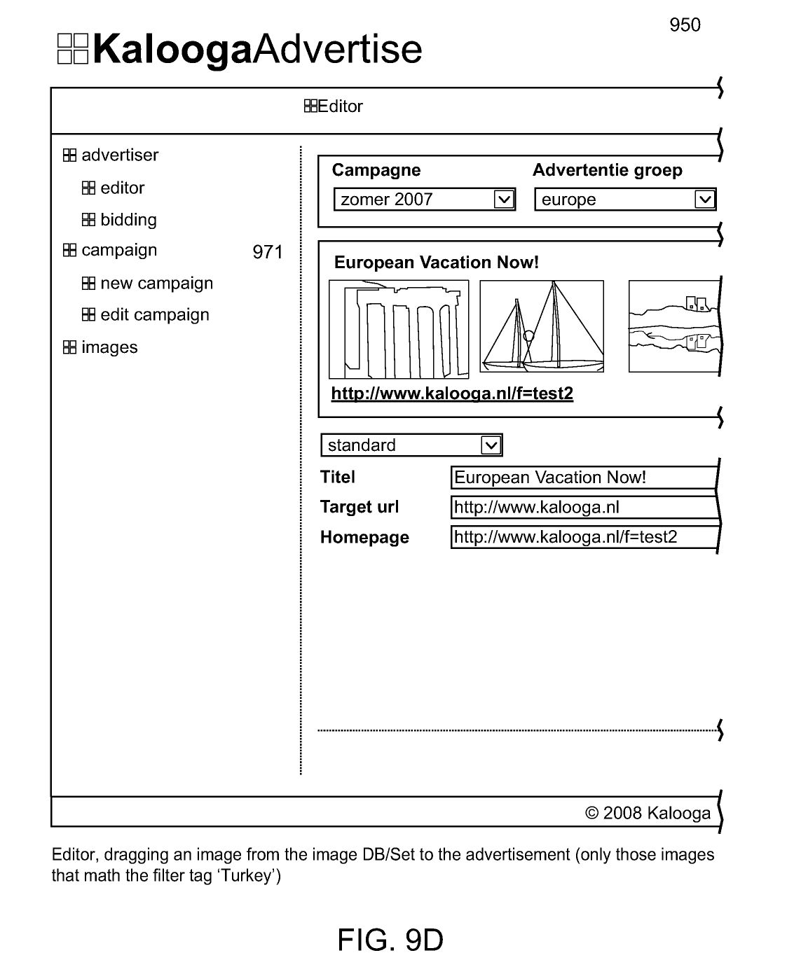

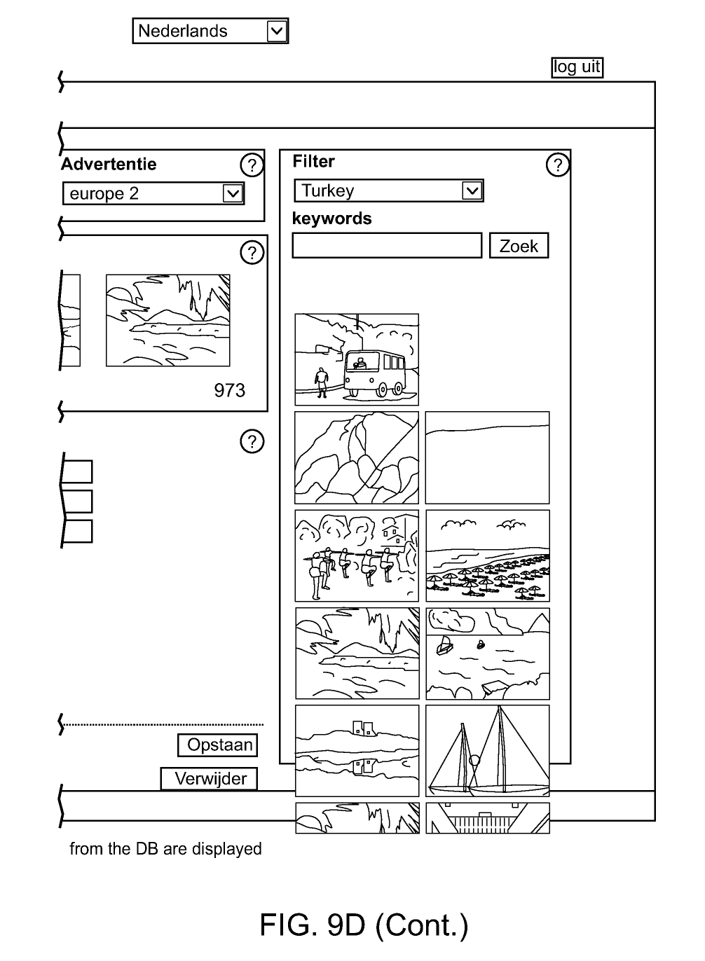

According to an embodiment, presentation system 120 (FIG. 1) may be implemented as a search engine (e.g. See an embodiment of FIG. 7) with sponsorship or advertisement tools to enable media-rich (or gallery type) campaigns or advertisements. More specifically, FIG. 9A illustrates a suite of web tools or functions for enabling sponsorship integration with a system such as described with FIG. 7, under another embodiment of the invention. In FIG. 9A, a suite of tools 900 includes one or more modules in the form of an interface 910, a sponsored search component 912, and a sponsorship presentation component 914. The sponsor interface 910 may enable a sponsor to add media objects, such as images (or dynamic images or video) for use in driving the sponsors campaigns. The sponsor search component 914 enables mechanisms to add sponsored links or renderings in connection with submission of search criteria. The presentation component 916 configures the manner in which the sponsor's media objects are rendered in connection with other gallery renditions that may be returned as part of a search result.

In FIG. 9A. a sponsor (e.g. advertiser, promoter) may interact with the interface 910 by providing sponsor input 902. The sponsor input identifies or defines the media objects that are available to the sponsor for use in campaigns. The sponsor input 902 may correspond to an upload of media objects. The media objects may be non-scaled or full-sized, in which case the interface 910 may optionally generate corresponding thumbnails. Components of the interface 910 include sponsor presentation layers 950, and tools corresponding to library manager 972, fetcher direct 974, tagger 976, and media/object URL association 978. Implementations of the sponsor presentation layers 950 are illustrated in FIG. 9B thru FIG. 9D, illustrating the various tools. Various items of data, input, metrics, and files may be specified and used for running advertisement or promotion campaigns in connection with presentation of gallery renderings on, for example, a search engine web site. These items of data and information may be stored on an advertiser database 901, which may be maintained separate or as part of, for example, the index (of other information) for creating gallery renderings.

FIG. 9B thru FIG. 9D illustrate implementations of specific interfaces that may be presented to the sponsor to receive input and data for creating campaigns. In FIG. 9B, the an instance of a first type of presentation layer 950 shows that the sponsor may create and maintain a library 972 of media objects 973. When the sponsor logs in, for example, to make or modify a campaign, the sponsor may be shown portions of his or her library 952. The sponsor may create the library, or modify its contents through the library manager 952. In order to create the library, the sponsor may upload the media objects through any one of many possible mechanisms, including having the interface library manager 952 read image elements off of a CD-Rom or removeable memory device or hard drive. Alternatively, the sponsor input 902 may specify URLs or links to media objects that are to be included in the sponsor's library. In an embodiment, the fetcher direct component 974 or the interface 910 (in connection with the library manager 952) may control an instance of the fetcher 520 (FIG. 5) to retrieve media objects located by individual URLs that are specified with sponsor input 902. Thus, for example, the sponsor may specify or import a list of URLs where images that are to be used in that sponsor's campaigns are to be provided.

From the library 972, a sponsor may create a campaign using various input user interface features provided on the presentation layer 950. FIG. 9B illustrates a standard campaign design page where the sponsor user defines a campaign via a campaign field 922, an advertisement (or promotion) group with the campaign 924, and individual advertisements 926 within the advertisement group. A display area may be provided for viewing individual advertisement (or promotion) 929. As described with one or more other embodiment, the advertisement 929 corresponds to renderings of images in a form that simulates the gallery renderings returned to the user as a search result. Each advertisement 929 may be assigned to a specific target URL 931 (provided in corresponding field), corresponding to the network location that the user (searcher or user of the search engine) is directed to in the event advertisement 929 is selected. A display URL 933 (provided in corresponding field) may provide what URL the user sees associated with the advertisement 929. Each advertisement 929 in a group may be provided its own target URL 931 (or they could all have the same URL). Other features that may be provided with an adgroup includes the ability for the user to rotate the advertisements 929 that comprise the group, particularly in response performance metrics such as click through rates. The association component 978 maybe used to create data associations between images of advertisements and URLs, and/or advertisements and URLs.

With each advertisement 929, the user may create a Title 935 with tags (which could also be provided as optional fields by the tagger component 974). When the user wishes to create an advertisement 929, he can select images that are to comprise the advertisement from the library 972. For example, the user may specify a set of 2-8 images that are to comprise the advertisement 929 with Title and optionally other descriptive information. When the user uploads images, the user can also tag the images with descriptive information and search for the images using a tag field 937 or search field 939.

FIG. 9C illustrates an advanced presentation layers 950 that the sponsor user can operate to specify target URLs 931 for each image element 939 in the advertisement 929. This may be used as an enhancement to providing one target URL for the entire advertisement 929.

FIG. 9D illustrates that within one of the presentation layers, the sponsor user may create advertisement 929 through drag drop operations between library 972 and the display area of the advertisement 929. As an alternative or addition, other simple user-interface operations may be used, such as check fields. With reference to the presentation layer 950 of FIG. 9D, the images 921 and 973 may be swapped from being active in advertisement 929 to being deactivated.

Once the sponsor user has created a campaign of one or more advertisements, the campaign may be executed. Time constraints and geographic parameters may be used when executing the campaign.

In order to present advertisement 929 with a search query, one embodiment provides that the use bids for a key word or search term. The user may bid for premium placement (e.g. first or top) or alternative placement (second or third). Premium placement may refer to the position on the page of the search result, from top to bottom. The user may place limits on bid amounts for various positions. When the query using the bid term is received, the advertisement 929 may be selected via the search component 912, and then presented by presentation component 914 in connection with other matching gallery renderings (see FIG. 8). In this regard, the presentation and search component 912 and 914 serve to integrate sponsored sets of media object renderings with an existing system, such as described with any other embodiment provided for herein.

Hardware

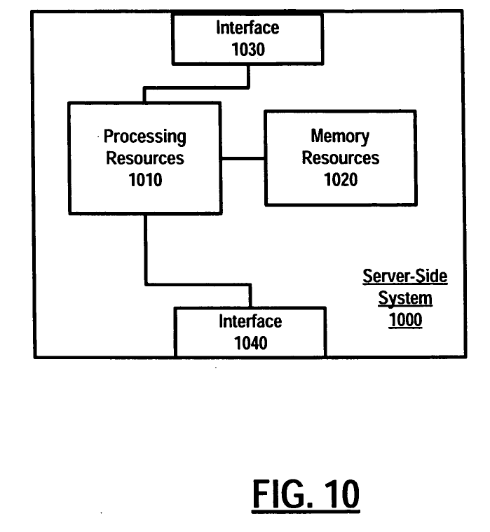

Embodiments described herein may be implemented through various types of networked systems, including client-server architectures, peer-to-peer systems, or combinations thereof. FIG. 10 illustrates a server-side system 1000 to implement or enable any of the embodiments described herein. A system 1000 may be shared and/or duplicated on more than one machine. In one embodiment, system 1000 includes processing resources 1010 comprising one or more processors, memory resources 1020 comprising both temporary and permanent memory, one or more back end network interfaces 1030 to enable functions such as crawling, and front-end user interfaces 1040 to handle client requests (assuming client-server architecture).

According to an embodiment, processing resources 1010 may be configured to implement any of the processes, steps, algorithms or functions provided with embodiments described above, including with embodiments of FIG. 2-7. Likewise, memory resources 1020 may include memory to store instructions for performing operations of the processing resources 1010, cache to hold information (e.g. such as stored form the parser 530, see FIG. 5), and/or memory to retain data structures for maintaining the gallery index (see gallery index 450). The back-end network interface 1030 may include hardware and logic to enable crawling and fetching operations such as described. The front-end network interface 1040 may handle user requests, or requests from programmatic components at other network locations.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

1. A computer-implemented method for aggregating collections of media objects from network resources available over a network, the method comprising performing programmatic steps of:
accessing a network resource at each of a plurality of network locations;
analyzing the network resource at each network location to determine whether the network resource includes, or provides access to, any or all media objects in a set of multiple media objects that collectively satisfy, as presented at the network location or network locations where the multiple media objects are provided, one or more editorial criteria for being deemed components of a gallery; and
storing information about the set of media objects, including information to locate each of the media objects.

2. The computer-implemented method of claim 1, wherein analyzing the network resource at each network location includes:
detecting one or more media objects embedded on the network resource, the one or more media objects being embedded with a link, wherein the link corresponds to a data structure or programmatic element that is activatable by a browser component to open a corresponding network resource;
activating the link to access the corresponding network resource;
analyzing the corresponding network resource for a corresponding media object that is a copy, a version or a derivative, of at least a portion any of the one or more media objects that are embedded with the link.

3. The computer-implemented method of claim 1, wherein analyzing the network resource at each network location includes:
detecting multiple images that are embedded with the network resource, each of the multiple images being embedded with a corresponding link that is activatable to directly access a corresponding linked network resource of the corresponding link;
activating the corresponding link embedded with each of the multiple images to access the linked network resource of the corresponding link; and
analyzing each linked network resource for a corresponding image that is a copy, a version or a derivitive of any one of the multiple detected images.

4. The computer-implemented method of claim 3, wherein the method further comprises detecting one or more markers of each detected image, and wherein analyzing each linked network resource for the corresponding image includes inspecting the linked network resource for an image that includes the one or more markers.

5. The computer-implemented method of claim 4, wherein the one or more markers correspond to metadata associated with that image.

6. The computer-implemented method of claim 4, wherein the one or more markers correspond to an aspect ratio, a color trait, or a dimension.

7. The computer-implemented method of claim 4, wherein detecting the one or more markers of each detected image includes identifying an object recognized from the detected image as at least one of the one or more markers.

8. The computer-implemented method of claim 4, wherein detecting the one or more markers of each detected image includes identifying one or more of (i) a presence or positioning of text provided with the detected image, or (ii) a keyword of the text provided with the image.

9. The computer-implemented method of claim 3, wherein detecting multiple images includes detecting a set of thumbnails.

10. The computer-implemented method of claim 1, wherein analyzing the network resource at each network location includes implementing analysis criteria that identifies the set of media objects as satisfying one or more editorial criteria for any of a plurality of different types of galleries.

11. The computer-implemented method of claim 8, wherein the editorial criteria corresponds to one or more of (i) a position or layout characteristic of the media objects in the set that are included on the network resource, (ii) a position or layout characteristic of multiple links in the network resource that collectively provided access to some or all of the media objects in the set, or (iii) a position or layout characteristic of the media objects included in a linked network resource that is provided linked access from the network resource.

12. The computer-implemented method of claim 8, wherein analyzing the network resource at each network location includes determining that the set of media objects satisfy an editorial criteria in which individual media objects in the set are related to one another by a content theme.

13. The computer-implemented method of claim 1, wherein analyzing the network resource at each network location includes detecting an image embedded within a programmatic segment of one or more of the network resources, and wherein the method further comprises extracting a network location that is identified within the script.

14. The computer-implemented method of claim 1, further comprising programmatically acquiring information about the set of media objects about a subject of the set of media objects, and using the information to determine one or more categories for the set of media objects; and wherein storing the information about the set of media objects includes storing the one or more categories for the set of media objects.

15. The method of claim 14, wherein acquiring information includes acquiring information from a network site that includes the plurality of network locations for the set of media objects as internal network locations.

16. The method of claim 14, wherein acquiring information includes acquiring information from a network location that is external to a network site that includes the plurality of network locations for the set of media objects as internal network locations.

17. The computer-implemented method of claim 1, further comprising programmatically analyzing (i) the media objects, or (ii) data associated or provided with the media objects, in order to determine one or more categories for the gallery, and wherein storing information includes storing data that identifies or corresponds to the one or more categories.

18. The computer-implemented method of claim 1, wherein analyzing the network resource at each network location includes analyzing each of a cluster of network resources that are directly or indirectly lined to one another.

19. The computer-implemented method of claim 1, wherein storing information includes storing data for creating a version or rendition of at least some of the media objects in the set.

20. The computer-implemented method of claim 1, wherein storing information includes storing (i) data for creating a version or rendition of at least some of the media objects in the set; and (ii) one or more category identifiers for the set of media objects.

21. The computer-implemented method of claim 1, wherein analyzing the network resource at each network location includes programmatically determining, from data elements that are not links, one or more inferenced network resources that contain one or more of the media objects in the set.

22. The computer-implemented method of claim 1, wherein analyzing the network resource at each network location includes recognizing a gallery page that provides at least a portion of the gallery, the gallery page rendering a plurality of media objects that correspond to components of the gallery.

23. A computer-implemented method for aggregating presentations of collections of media objects from network pages available over a network, the method comprising performing programmatic steps of:
analyzing one or more pages to identify a plurality of media objects, the plurality of media objects being provided at one or more network locations; and
analyzing data, that is either contained in or associated with, individual media objects in the plurality of media objects in determining that at least one set of media objects satisfy one or more editorial criteria for being deemed components of a gallery when provided at the one or more network locations.

24. The method of claim 23, further comprising:
indexing gallery information for the gallery, including information that for enabling presentation of a rendition of at least a portion of the set of media objects in the gallery.

25. The method of claim 23, further comprising presenting the rendition of at least the portion of the set of media objects in the gallery.

26. The method of claim 24, further comprising receiving a selection criteria, and wherein presenting the rendition of at least the portion of the set of media objects is performed in response to receiving the selection criteria.

27. The method of claim 23, wherein the editorial criteria corresponds to one or more of (i) a positioning of the media objects in the set that are included on the network page, (ii) a positioning of multiple links in the network page that collectively provided access to some or all of the media objects in the set, or (iii) a positioning of the media objects included in a linked network page that is provided linked access from the network page.

28. The method of claim 23, wherein the editorial criteria corresponds to data, included or associated with individual media objects in any set that is deemed a given gallery, that relate the individual media objects of that set by a content theme.

29. The method of claim 23, further comprising analyzing the data provided from one or more of the pages in determining one or more labels for association with at a given one of the identified galleries.

30. The method of claim 29, wherein analyzing the data provided from one or more of the pages includes identifying a key word that is provided on the page, or with any of the media objects of the given gallery, and designating the category or key word for association with the given gallery to correspond to or be based on the identified keyword.

31. The method of claim 29, wherein determining one or more labels includes detecting and analyzing one or more factors to estimate a relevance score for each of the one or more determined categories.

32. The method of claim 29, wherein detecting and analyzing one or more factors includes (i) detecting a candidate keyword in the page of at least one of the media objects that comprises the given gallery, (ii) determining whether the page is primarily image-based, and (iii) determining a relevance score of the candidate keyword based in part on whether or not the page is primarily image-based.

33. The method of claim 29, wherein analyzing the data provided from one or more of the pages in determining one or more labels for association with the given gallery includes detecting a comment section on the page, and analyzing the text of the comment section to identify at least one of the categories.

34. The method of claim 29, wherein analyzing the data provided from one or more of the pages in determining one or more labels for association with the given gallery includes detecting a title of one of the pages that contains a media object of the given gallery.

35. The method of claim 23, wherein analyzing the data includes identifying a gallery page that comprises at least a portion of a gallery, the gallery page including a plurality of media objects that are presented with contextual information.

36. The method of claim 35, wherein analyzing the data includes identifying a theme or subject of the gallery from the contextual information.

37. A computer system for aggregating collections of media objects from network resources available over a network, the system comprising one or processors that execute programmatic instructions and operate with memory and other hardware resources to provide one or more modules that include:
a crawler, executable to retrieve a plurality of network resources at a plurality of network locations;
a set of rules that establish when a collection of media objects are deemed a gallery;
a resource analyzer, executable to analyze the plurality of network resources, and to identify, from a given network resource or cluster of network resources, that a set of media objects forms a gallery, based on rules in the rule set; and
a data structure, the resource analyzer being coupled with the data structure to identify data to enable at least some of the media objects that form the identified gallery to be subsequently rendered together in one presentation.

38. The computer system of claim 37, wherein the resource analyzer is executable to detect a marker that indicates a particular media object is a candidate member of a gallery with one or more other media objects in the given network resource or cluster of network resources.

39. The computer system of claim 38, wherein in response to detected the marker, the resource analyzer executes to seek other media objects in either (i) the given network resource, or (ii) in the cluster of network resources that have a link relationship of either a parent, a sibling, a child, or a grandchild to the given network resource.

40. The computer system of claim 37, further comprising a cache, provided for the resource analyzer, wherein the resource analyzer stores data from scanning or analyzing individual network pages in the cache.

41. The computer system of claim 38, further comprising a cache, provided for the resource analyzer, wherein the resource analyzer stores data from scanning or analyzing individual network pages in the cache;
wherein the resource analyzer is executable to detect a marker that indicates a particular media object is a candidate member of a gallery with one or more other media objects in the given network resource or cluster of network resources
wherein in response to detected the marker, the resource analyzer executes to seek other media objects in the cluster of network resources that have a link relationship of either a parent, a sibling, a child, or a grandchild to the given network resource; and
wherein the resource analyzer seeks the other media objects by inspecting or analyzing the other network resources in the cluster, and stores data that corresponds at least to a portion of detected media objects in each of the network resources of the page, in order to determine whether the particular media object and any of the stored media objects satisfy the rule sets that defines the gallery.

42. The computer system of claim 41, wherein the resource analyzer executes to control a fetcher to retrieve individual network resources in the cluster.

43. The computer system of claim 41, wherein the resource analyzer executes to compare individual media objects from any of the stored media objects to the particular media object.
